(19) United States
(12) Patent Application Publication
(10) Pub. No.: US 2025/0296846 A1
(43) Pub. Date: Sep. 25, 2025

(54) SUB-SURFACE GEOTHERMAL AMMONIA PRODUCTION SYSTEM

(71) Applicant: GOOD WATER ENERGY LTD, Claremont, Western Australia (AU)

(72) Inventor: Warren Ross STRANGE, Claremont, Western Australia (AU)

(21) Appl. No.: 18/861,828

(22) PCT Filed: May 3, 2023
(86) PCT No.: PCT/AU2023/050369

§ 371 Date: Oct. 30, 2024

(30) Foreign Application Priority Data
May 3, 2022 (AU) 2022901161

(51) Int. Cl. C01C 1/04; B01D 53/00; C25B 1/04

(52) U.S. Cl. CPC C01C 1/0447; B01D 53/00; C01C 1/0411; C25B 1/04; B01D 2257/102

(57) ABSTRACT

The present disclosure is directed to a sub-surface geothermal ammonia production system, comprising; a geothermal well having an inlet in fluid communication with an injection bore, and an outlet in fluid communication with a production bore, the inlet configured to receive a fluid mixture of hydrogen and nitrogen, and the outlet producing a fluid ammonia; and a catalyst disposed within the geothermal well, wherein the fluid mixture of hydrogen and nitrogen is drawn into the injection bore of the geothermal well absorbing thermal energy from geology surrounding the well before entering the production bore of the geothermal well, whereby the heated fluid mixture of hydrogen and nitrogen is drawn into contact with the catalyst to convert the fluid mixture of hydrogen and nitrogen into the fluid ammonia within the well.

### CROSS-REFERENCE TO RELATED APPLICATIONS

The present application is a National Stage of International Application No. PCT/AU2023/050369 filed on May 3, 2023, which claims priority from Australian Application No 2022901161, filed 3 May 2022, the entire contents of which are hereby incorporated by reference.

### FIELD

The disclosure is directed to a sub-surface geothermal ammonia production system. The system can be driven directly from a geothermal well or indirectly driven from a geothermal well using a binary heating circuit. The disclosure is further directed to a method of sub-surface geothermal ammonia production.

### BACKGROUND

In recent years, stringent emissions regulations and ambitious zero-carbon energy goals have mostly relied on wind and solar energy as the prominent green energy generation source. This is coupled with an increasing awareness that ensuring energy security from these low-carbon intermittent green energy sources requires long-term sustainable energy storage and the identification of suitable carriers. However, Australia continues to struggle with unreliable, expensive and intermittent solar and wind energy generation that requires expensive and toxic material batteries and gas fired electricity to provide the baseload requirements.

Recent developments such as: the introduction of carbon dioxide (CO2) emission reduction mandates; the growing awareness of climate change; higher costs of living as more solar and wind energy is introduced to the mix of electricity provision; and the highly volatile oil and gas industry pushing the price of fuel above the level that most Australians can afford, have opened the door for geothermal energy development once again in Australia.

The rapidly decreasing cost of renewable energy generation is putting “green” hydrogen under the spotlight as a promising energy carrier for a number of applications. However, storage, handling, and transportation of hydrogen is both challenging and expensive. While green hydrogen can be compressed or liquefied for storage and transport, the process is expensive and dangerous, forcing people to consider alternative energy carriers, such as ammonia (NH3).

Ammonia is already an important product for global food production being used to produce fertiliser to feed the population. However, present methods of ammonia production involve separating nitrogen from the air using fossil fuel driven systems and combining this nitrogen gas with hydrogen: typically derived from gas or coal. This process, while functional, is dirty and adds to the world's CO2 emissions.

As an alternative energy carrier, ammonia is similar to other fossil fuels being both a chemical energy carrier and a potential fuel, where energy is released by the breaking of chemical bonds. However, ammonia is particularly well suited as a green hydrogen carrier for the following reasons:
Ease of storage and transportation, because the energy storage properties of ammonia are similar to those of methane, the infrastructure is already in place for Ammonia. There are established logistics and end-use markets: The ammonia supply chain is mature thanks to its widespread use as a feedstock for inorganic nitrogen containing fertilizers and a variety of other industrial chemicals.
The volumetric energy density of ammonia is 150% of liquid hydrogen and these hydrogen densities can be achieved at near ambient storage conditions. Ammonia does not require the high pressures or low temperatures of pure hydrogen to achieve useful volumetric hydrogen density.
Ammonia has a lower explosive limit in air than pure hydrogen. As a result, the storage of ammonia is easier, less energy intensive and cheaper than storing hydrogen.
Green ammonia does not release any carbon emissions during processing and if used as a fuel does not produce any NO2 emissions.

While ammonia offers an enticing energy carrier solution, the ammonia production industry is currently classified as a major hazard and has a history of chemical leaks, fires and explosions. The source of fires and explosions in the ammonia production industry are generally the raw materials in the form of highly flammable natural gases like hydrogen, and nitrogen, mixing and/or reacting with ammonia in high temperature and high pressure vessels required as a part of the production process. These vessels pose a major health and safety risk to personnel working in and near to the ammonia production plant.

In a typical ammonia plant, most accidents are due to the release of ammonia. The severity and damage of any resulting accident is increased by the high temperature and high pressure vessels within the ammonia production plant, which are typically installed in proximity to factory workers and personnel. These risks are difficult to mitigate, as a fundamental part of the production process, and difficult to avoid.

Ammonia is generally manufactured in three basic process steps: High pressure catalytic reforming of natural gas, purification of gases and ammonia synthesis. The first two steps involve the production of a hydrogen gas, the introduction of nitrogen in stoichiometric proportion and the removal of carbon dioxide, carbon monoxide and water, which are catalyst poisons. Ammonia synthesis involves the catalytic fixation of nitrogen at very high temperature and pressure for the recovery of ammonia. A major cause of failure in the ammonia process is the failure of the catalyst within the high pressure and high temperature secondary reformer. The catalyst serves to accelerate chemical reactions that occur inside the reformer; however, a non-functioning catalyst can increase the secondary reformer temperature to a level where it has the potential to explode.

The present disclosure was conceived with these shortcomings in mind.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

### SUMMARY

The disclosure is broadly directed to a system for producing ammonia, by generating very low-cost, baseload electricity from exhausted thermal energy and converting this energy via turbines/expanders and heat exchangers to: feed and power the desalination of salt water by Multi Effect Distillation (MED); feed and power a hydrogen electrolyser to generate hydrogen; feed and power a nitrogen plant to harvest nitrogen from ambient air; and force the harvested nitrogen and generated hydrogen, under pressure, into contact with a catalyst to create ammonia without the requirement for supplementary electrical power.

In a first aspect of the disclosure, there is provided a sub-surface geothermal ammonia production system, comprising: a geothermal well having an inlet in fluid communication with an injection bore, and an outlet in fluid communication with a production bore, the inlet configured to receive a fluid mixture of hydrogen and nitrogen, and the outlet producing a fluid ammonia; and a catalyst disposed within the geothermal well, wherein the fluid mixture of hydrogen and nitrogen is drawn into the injection bore of the geothermal well absorbing thermal energy from geology surrounding the well before entering the production bore of the geothermal well, whereby the heated fluid mixture of hydrogen and nitrogen contacts the catalyst to convert the fluid mixture of hydrogen and nitrogen into the fluid ammonia within the well. The catalyst may contain iron.

In some embodiments, the fluid ammonia may be drawn from the outlet of the production bore into a primary fluid circuit to drive a first turbine powering an electrical generator. The primary fluid circuit may deliver thermal energy from the fluid ammonia to a desalination plant configured to produce distilled water from a salt water source. The distilled water from the desalination plant may be communicated to a hydrogen electrolyser to produce hydrogen and oxygen. The hydrogen electrolyser may be powered by electricity from the electrical generator. The hydrogen from the electrolyser may be communicated to a receiver to be mixed with a nitrogen source to create the fluid mixture of hydrogen and nitrogen.

The ammonia production or “synthesis” process at the bottom of the geothermal well is an exothermic reaction and thus releases energy in the form of heat. The chemical reaction is given below.

N₂(g)+3H₂(g)→2NH₃(g)

This generation of heat will further increase the temperature of the geothermal environment in and immediately adjacent the well.

The system of the disclosure produces ammonia while the geothermal well powering the system is used as the vessel in which the ammonia is produced. The system as described herein generates electricity, distilled (or fresh) water, hydrogen and nitrogen, thereby providing all the necessary components for ammonia production from a zero-emission energy source. Additionally, the system produces other commercial bi-products in the form of oxygen, salt brine and drinking water. The system uses a desalination plant to convert salt water to distilled water, which is in turn used to feed the hydrogen electrolyser to disassociate the distilled water into hydrogen and oxygen. The hydrogen is then mixed with a nitrogen source from eg. a nitrogen plant, to create the required fluid mixture of hydrogen and nitrogen, which in the presence of a catalyst, high temperature and high pressure, will transform the fluid mixture into fluid ammonia. Both the distilled water production and the electricity generation to supply the electrolyser are powered from geothermal energy either directly or indirectly. The geothermal energy is drawn from one, or a plurality, of geothermal wells the output of which is highly controllable based on the fluid input to the well head/s of the injection bore/s.

The geothermal well provides thermal energy to the fluid mixture drawn from geology surrounding the geothermal well, and delivers a heated and pressurised fluid ammonia from the production bore of the geothermal well. The fluid ammonia is at temperatures in excess of 350° C. and requires cooling before being stored or transported. In order to efficiently utilise the residual heat from the fluid ammonia, the ammonia is communicated around the primary fluid circuit, and the thermal energy within the fluid ammonia is put to work in driving a turbine to power an electrical generator which subsequently powers other components of the system. After dissipating thermal energy to the turbine there is still sufficient heat energy in the primary fluid circuit to power a desalination plant converting salt water into distilled water to feed the hydrogen electrolyser. As the thermal energy is drawn from the fluid ammonia in the primary fluid circuit the fluid ammonia drops in temperature ready for collection at about 40° C. and subsequent storage and/or transportation.

The electricity from the generator is used to power the hydrogen electrolyser and a nitrogen plant to harvest nitrogen from ambient air. In this manner, the ammonia production process requires no additional electrical input, and can deliver a truly “green” ammonia production system. Further benefits are anticipated in that the chemical reaction converting the fluid mixture of hydrogen and nitrogen into ammonia (ammonia synthesis) occurs deeply within the geothermal well, preferably thousands of metres below the ground, and away from plant and plant personnel, thereby reducing risk to personnel in the event of a leak or an explosion.

With the capability of reaching bedrock temperatures in excess of 300° C.+ in most Australian locations, a thermal syphoning effect will provide substantially all of the thermal energy production at the surface once the primary fluid circuit is flowing. This means that in a “closed loop” geothermal well or multi well system, no pumps are required to deliver the heated fluid ammonia to the surface, and the average thermal energy production cost is calculated to be as low as A$0.50c per MWt.

Delivering this low cost geothermal produced green hydrogen, distilled salt (sea) water and nitrogen extracted from the atmosphere with waste thermal energy, to a reaction vessel (or geothermal well) will produce very low cost green ammonia.

### Ammonia Production Process

Ammonia is the second-most-widely produced commodity chemical globally and is mostly utilised in agriculture as a fertilizer, a sector that is under increasing scrutiny due to its environmental impact. Ammonia can be synthesized from nitrogen and hydrogen via various methods; the Haber-Bosch process is currently the only method used on a commercial scale.

Present ammonia production involves separating nitrogen from the air using fossil fuel energy sources and combining it with hydrogen using the Haber-Bosch Process (HBP) to form ammonia. The HBP converts atmospheric nitrogen (N₂) to ammonia (NH₃) by a reaction with hydrogen (H₂) using a metal catalyst under high temperatures (400° C.-500° C.) and pressures (10 MPa+), as shown in the Chemical reaction set out above.

The conversion is typically conducted with steam using high-temperatures and high-pressures inside a reformer which uses a nickel catalyst to separate the carbon and hydrogen atoms. The catalyst is required because nitrogen (N₂) is highly unreactive due to triple atomic bonds, and the catalyst accelerates the breaking of these atomic bonds. Typically, the HBP uses heterogeneous or solid catalysts to interact with gaseous reagents. Typical catalysts are ferrite based with an iron oxide carrier.

A primary drawback for the adoption of green ammonia for fertilizer and industrial applications is the high cost of production using solar and wind energy to produce green ammonia using the Haber Bosch process. However, the present disclosure provides a green ammonia production system that can underpin a fully carbon-free agricultural or industrial supply chain for green ammonia.

Aside from its renowned fertilizing properties ammonia is also an excellent energy carrier with an energy density greater than that of hydrogen. When in liquid form, at ambient temperature, ammonia has an energy density of about 3 kWh/litre and if chilled to negative 35° C., this can be increased to almost 4 kWh/litre. In addition, ammonia requires a much smaller storage volume than hydrogen and is less reactive than hydrogen burning at a lower temperature with reduced flame speed and a narrow flammability range.

Ammonia can be used directly in ammonia-fired turbines and engines, for example as a marine fuel. Its zero-carbon emissions and zero-sulphur content result in reduced emissions of particulates and improved air quality to comply with IMO 2020 and IMO 2050. Unlike “brown” or dirty ammonia, which is made using a fossil fuel (mostly from natural gas) as the feedstock, the raw materials for green ammonia are hydrogen-obtained through renewable energy driven electrolysis of zero emission water and nitrogen-obtained from air using a standard air separation unit driven by renewable energy. Currently, due to the fluctuating and unreliable production levels and high costs of solar and wind driven energy sources, green ammonia production is limited to small-scale pilot plants.

Ammonia is particularly suited to contribute to a hydrogen-based economy because the supply chain and logistical infrastructure for ammonia trade is mature and very well developed. This existing logistical infrastructure is a key advantage over hydrogen and could enable the early adoption of large-scale transportation of ammonia as an energy carrier and fuel. Additionally, ammonia can be liquefied at about 7.5 bar, at ambient temperatures, similar to propane and butane, providing further advantages over known products (like liquefied natural gas (LNG) which requires cryogenic storage) providing zero emission alternatives to the shipping industry.

While ammonia carries some risks, being toxic, the risk is not dissimilar to other gases, for example, methane or methanol. However, unlike many toxins, ammonia dissipates quickly and begins self-neutralising when spilled. As such, ammonia does not accumulate in the ground and can be taken-up by plants and bacteria facilitating nitrification.

The disclosure uses geothermally produced electricity, and zero emission distilled water to supply the hydrogen electrolyser with hydrogen to be disassociated into oxygen and hydrogen. As both the electricity and the water produced by the above system do not produce emissions, the resulting ammonia can be truly labelled “green”. The sub-surface geothermal ammonia production system of the disclosure can produce 24-hour, round the clock ammonia, without the use of batteries or electricity transmission. It is calculated that this system can meet Australian base load requirements providing constant renewable thermal energy, electricity and water delivery for maximum ammonia production.

It is anticipated, that the system described herein is capable of producing between 2,000 to 10,000 Kg of ammonia per hour, from each geothermal well. As such the system can be scaled to the required output for the Australian and export markets on the basis that one Hectare of land can accommodate up to 10,000 tonne of green hydrogen production per year. This is to be contrasted with alternative energy sources like solar which require considerably more land, for example in a single Hectare of solar energy panels could produce just 87 tonne of hydrogen per year.

An additional benefit to the system described herein is the capital expenditure required to install and maintain such the system, which is significantly lower than that of solar or battery powered hydrogen production plants. The system requires no fossil fuel, solar or wind generated electricity, no transmission of electricity, no clearing of trees for transmission lines, and no emissions or toxic waste.

The output of the system can be easily varied and is fully flexible, based on output from the production bore of the well, between 0%-100% of flow volumes achieved by remotely varying the fluid flow at the well head. Additional saving are made on maintenance and running costs, as once drilled and installed, a single geothermal well can produce thermal energy at very low cost for hundreds of years.

In a second aspect of the disclosure, there is provided sub-surface geothermal ammonia production system, comprising: a geothermal well having an injection bore and a production bore, the injection bore drawing a fluid mixture of hydrogen and nitrogen into the well and forcing the fluid mixture into contact with a catalyst such that the production bore delivers a heated, pressurised fluid ammonia to a primary fluid circuit; a desalination plant configured to received thermal energy from the primary fluid circuit to convert a salt water source into distilled water, at least one turbine driven from the primary fluid circuit and configured to power an electrical generator to generate electricity; and a hydrogen electrolyser powered from electricity generated by the electrical generator and filled with distilled water from the desalination plant, to thereby disassociate the distilled water into a hydrogen output and an oxygen output, the hydrogen output directed to a receiving tank for mixing with a nitrogen source to form the fluid mixture of hydrogen and nitrogen for introduction into the injection bore of the geothermal well, wherein the fluid ammonia of the primary fluid circuit, having dissipated thermal energy to the at least one turbine and the desalination plant, is collected in fluid form.

In some embodiments, the production bore is coaxially located within the injection bore of the geothermal well. The fluid mixture of hydrogen and nitrogen may be compressed before entering the injection bore of the geothermal well. Water may be added to the fluid mixture of hydrogen and nitrogen before it is introduced into the injection bore of the well. The additional water content entering the well will increase the pressure within the well and increase the efficiency of the ammonia production process.

The fluid ammonia may be drawn through a cooler before being collected. The cooler may be a salt water cooler, using salt water from the salt water source to draw residual heat from the fluid ammonia before collection. The fluid ammonia drawn from the outlet of the production bore may be predominantly in gas form. The fluid ammonia drawn from the outlet of the production bore may be at temperature of 300° C. and above. The fluid ammonia drawn from the outlet of the production bore may be at pressures of 5000 psi.

In some embodiments of the system, a flash separator may be used to further heat the fluid ammonia of the primary fluid circuit at an inlet of the first turbine. The fluid ammonia within the primary fluid circuit may be drawn across a second turbine configured to power an inlet or injection compressor for compressing the fluid mixture of hydrogen and nitrogen before entering the injection bore of the geothermal well. The inlet compressor may be powered by electricity from the electrical generator to compress the fluid mixture of hydrogen and nitrogen before entering the injection well. A second flash separator may be used to further heat the fluid ammonia exhausted from the first turbine at an inlet of the second turbine.

In some embodiments, electricity from the electrical generator may be used to power a salt water pump to deliver salt water from the salt water source to the desalination plant. A brine salt may be collected from the desalination plant as a bi-product of the sub-surface geothermal ammonia production system.

In some embodiments, the salt water source may be drawn through a cooler to cool the fluid ammonia in the primary fluid circuit before the fluid ammonia is drawn from the primary fluid circuit for storage or sale. The cooler may comprise a gas separator allowing unreacted fluid mixture of hydrogen and nitrogen in gaseous form to be redirected back into the primary fluid circuit for reinjection into the injection bore.

In some embodiments, the oxygen from the electrolyser may be reintroduced to the salt water source. The hydrogen may be communicated to the receiver by a hydrogen pump, driven by electricity from the electrical generator. Ambient air may be drawn into a nitrogen plant and separated to provide the nitrogen source and a distilled water output. The distilled water output from the nitrogen plat may be redirected to the hydrogen electrolyser to provide a secondary distilled water source to top-up the electrolytic solution. The nitrogen from the nitrogen plant may be communicated to the receiver by a nitrogen pump, driven by electricity from the electrical generator. An additional distilled water output may be drawn from the receiver and redirected to the hydrogen electrolyser to provide a tertiary distilled water source.

In some embodiments, the geothermal well may comprise at least one injection bore and a plurality of production bores each production bore having an outlet for feeding the fluid ammonia into the primary fluid circuit. In some embodiments, the geothermal well may comprise at least one injection bore and four production bores, each bore of the well in fluid communication with each remaining bore, each bore of the well arranged in a series having the injection bore centrally located of the series. Each of the injection and production bores of the geothermal well may comprise a flow valve to control the flow volume of fluid mixture of hydrogen and nitrogen entering the geothermal well and the flow volume of fluid ammonia exiting each of the production bores of the geothermal well. The plurality of flow valves of the well may provide a control means to control and vary the volume of fluid entering and exiting the geothermal well, thereby controlling the thermal energy drawn from the well.

In some embodiments, the injection bore of the geothermal well may have a depth of between 3,000-12,000 metres. A bottom-hole temperature of the geothermal well may be between 400° C.-500° C. The fluid ammonia may be drawn-up the production bore by the thermal siphoning effect. The fluid mixture of hydrogen and nitrogen may form a spiral flow within the injection bore under a Coriolis Effect.

In some embodiments of the disclosure, each of the plurality of production bores may comprise a catalyst disposed therein. Each bore may be spaced from a subsequent bore by about 50 metres. The production bore may be defined by a vacuum insulated tubing. The vacuum insulated tubing may have a wall thickness of between 30-60 mm.

In some embodiments, the fluid mixture of hydrogen and nitrogen may be drawn into the injection bore of the geothermal well by a thermal syphoning effect. The fluid ammonia may be forced out of the production bore of the geothermal well by the thermal syphoning effect.

The electrolyser comprises a distilled water outlet which may be configured to eject unreacted water into the salt water source or a feed line from the salt water source to the cooler. The distilled water outlet may comprises a check valve for controlling the release of unreacted distilled water from the electrolyser.

In some embodiments of the disclosure, the catalyst may contain iron. The catalyst may be confined to the production bore of the geothermal well. The catalyst may be removably disposed within the production bore of the well. The catalyst may be located towards a bottom of the injection bore and positioned between the injection bore and the production bore to maximise contact between the fluid drawn into the injection bore and the catalyst.

In some embodiments, the catalyst may extend along the production bore for 500-3,000 metres. While, in some embodiments, the vacuum insulated tubing defining the production bore may be formed from iron or a material comprising iron to form the catalyst therefrom. The catalyst may be configured to line the production bore of the geothermal well. The catalyst may be suspended within the production bore of the well. The catalyst may be in a particulate form. The particulate catalyst may be bounded by an open cage to facilitate exposure between surface area of the particulate catalyst and the fluid mixture of hydrogen and nitrogen entering the production bore.

In some embodiments, the nitrogen plant may be configured to be powered by electricity from the electrical generator whereby the nitrogen plant draws ambient air therein to provide a nitrogen source communicated to the receiving tank for mixing with the hydrogen output from the electrolyser. The ambient air may be drawn into the nitrogen plant powered by electricity from the electrical generator to provide a nitrogen source to the receiving tank. The hydrogen from the electrolyser and the nitrogen from the nitrogen plant may be pump by a hydrogen pump and a nitrogen pump powered by electricity from the electrical generator.

In some embodiments, a salt water pump may be powered by electricity from the electrical generator to pump the salt water source to the desalination plant. The oxygen generated within the hydrogen electrolyser may be reintroduced to the salt water source.

The fluid ammonia within the primary fluid circuit may be fed through a gas separator to remove unreacted hydrogen and nitrogen gases from the fluid ammonia before collection. A plurality of gas separators may be incorporated into the primary fluid circuit to remove unreacted gases from the fluid ammonia. The separator may be configured to remove unreacted gases and water from the fluid ammonia prior to its collection. The cooler may be charged with salt water. The cooler may include a gas separator configured to draw unreacted hydrogen gas and nitrogen gas from the fluid ammonia and direct the unreacted hydrogen gas and nitrogen gas back into the injection bore of the geothermal well.

The fluid ammonia containing thermal energy passes through the desalination plant divesting thermal energy to distil the salt water in the desalination plant to produce fresh water and brine. The primary fluid circuit is sustained by a thermal syphoning effect, providing a flow of the primary fluid to the outlet of the deep geothermal well.

Thermal syphoning is a mode of passive heat exchange sustained by convection to circulate the fluid within the primary fluid circuit without the requirement for mechanical pumps. Once a heat transfer is initiated to a first part of the circuit, the change in temperature will give rise to a change in density, urging the hotter, less dense fluid in one part of the circuit to rise, as cooler, denser fluid in the circuit sinks: using natural convection to draw the fluid around the circuit to and from the heat source. The thermal syphoning effect provides a naturally driven flow of the fluid ammonia to the outlet of the well as the fluid mixture of hydrogen and nitrogen is compressed and drawn into the injection bore of the well to be heated by the hot geology, requiring no energy input to maintain the fluid flow.

In some embodiments a portion of the heated ammonia fluid may be subject to pressure change to drive the turbine. The ammonia fluid may be subject to pressure change in a separator or flash separator. A portion of the ammonia fluid in the primary fluid circuit may be outputted from the separator or flash separator and mixed with ammonia fluid in the primary fluid circuit exhausted from the turbine to increase the temperature of the ammonia fluid in the primary fluid circuit. Any residual fluid from each separator or flash separator may be reintroduced into the primary fluid circuit.

In one embodiment, the system may provide an organic Rankine Cycle or ORC or secondary fluid circuit to power the turbine and supply the desalination plant with thermal energy. The secondary fluid circuit may receive energy from the primary fluid circuit via a heat exchanger and is thus supplied indirectly from the geothermal well. Producing electricity, distilled water and hydrogen from the secondary fluid circuit is still a “green hydrogen” and therefore a “green ammonia” production system.

The heat source provided by the ORC-turbine (ie. a turbine powered from the thermal energy of the ORC or secondary fluid circuit) exhaust to the MED plant will produce high grade distilled water from salt water at very low cost. Modelling by Schlumberger and other experts in the field of desalination predict production costs at below A$0.20c per kL for this high-grade distilled water, produced from salt or sea water within 5 kms of the MED plant.

Distilled water produced by the MED plant can be delivered to the hydrogen electrolyser where the low cost, green, AC or DC current electricity produced by the ORC-turbine, can produce green hydrogen at a cost well below US$1.00 per kg.

In some embodiments, the heat exchanger may transfer thermal energy to a working medium in the secondary (ORC) circuit. The turbine is then driven by the thermal energy in the working medium of the secondary circuit. The working medium of the secondary circuit may be N-Pentane.

In some embodiments, a second desalination plant is configured to receive thermal energy from the secondary circuit. The second desalination plant may be driven simultaneously with a first desalination plant configured to receive thermal energy from the primary fluid circuit.

In some embodiments the primary fluid circuit may comprise a meter to measure the volume of fluid ammonia drawn from the cooler. Each of the first and the second desalination plants may comprise respective coolers, drawing salt water from one or more salt water sources through the respective coolers before introducing the salt water at an elevated temperature to the respective first and second desalination plants. Each cooler may be configured to draw in salt water at an ambient temperature from the salt water source as a coolant, the salt water absorbing thermal energy from the fluid ammonia in the primary fluid circuit, such that the salt water exits the cooler to be delivered to the desalination plant at an elevated temperature. The cooler may be a heat exchanger.

In some embodiment, the secondary circuit may comprise a circuit pump (or ORC pump) driven by electricity from the electrical generator to drive the working medium around the secondary circuit.

In some embodiments, the receiver may be any one of: a receiving tank; a mixing tank; a pump; and a mixing valve.

Utilising a standard nitrogen production plant, driven by the low cost, green, DC electricity produced by the ORC or secondary circuit, nitrogen, oxygen and water can be separated from ambient air, wherein the nitrogen can be used to produce green ammonia. Without the requirement for compression, this green nitrogen and the green hydrogen produced by this process, can be combined at the correct mixture and delivered to the injection bore of the geothermal well as described herein. In some embodiments, the nitrogen and hydrogen produced by the system may be mixed and then compressed, or the supplies of nitrogen and hydrogen can be individually compressed, then mixed, before being directed to the injection bore of the geothermal well.

Salt water can be pumped with the low-cost, green, DC electricity produced by the system and this flow of salt water can be used to further cool and condense the ammonia being pushed by the thermal syphoning effect from the production bores of the geothermal well or wells. Salt water can also be pumped by a steam or vapour driven pump or screw expander driven pump using exhausted thermal energy from various stages in this geothermal green ammonia production system.

This system requires no outside or third party energy supply. All of the energy required for each of the required processes is generated from the heat that is contained in the ammonia as it is forced from the production bore/s of the well under pressure by the thermal syphoning affect. The heat energy is extracted from the ammonia for the purposes of electricity generation, water pumping and treatment, hydrogen production and nitrogen production without using any of the ammonia. Unprocessed or unreacted gasses within the fluid ammonia are drawn back into the injection bore/s of the geothermal well by the thermal syphoning effect to be re-processed in the safe environment of the well, kilometres below the surface.

The described systems herein will still require high temperature piping on the surface that will pose some level of low risk to persons; however, the extremely high pressure and high temperature environment required for the ammonia production is positioned several kilometres (kms) below the surface in solid bedrock and poses a minimal risk or hazard to persons or equipment on the surface.

As the working medium of the secondary fluid circuit passes through the desalination plant, the thermal energy therein is used to distil the salt water (or sea water) in the desalination plant before the working medium is directed back to the heat exchanger to be reheated. As the working medium passes through the desalination plant is divests thermal energy to the plant to distil the salt water into distilled (or fresh) water and salt brine.

In some embodiments the working medium in the secondary circuit may be a binary fluid having a low-boiling point. The working medium may be N Pentane. The working medium in the secondary circuit may be communicated to the desalination plant before returning to the heat exchanger to be re-heated.

In some embodiments the primary fluid circuit can be initiated by an inlet compressor, and once circulating will be sustained by the thermal syphoning effect drawing fluid into the geothermal well at a first temperature as heated fluid is forced out of the well head at a second temperature, greater than the first temperature. The inlet or injection compressor can be deactivated once the primary fluid circuit is flowing as the thermal syphoning effect will provide a natural pumping action to maintain fluid movement in the primary circuit.

The salt water may be sprayed into the first chamber of the desalination plant, heated by the flow of working medium in the secondary circuit passing therethrough.

Thermal heat drawn from the geothermal well is used to provide thermal heat energy to the desalination plant which will boil sea or salt water in a vacuum state inside of the MED desalination plant.

The disclosure uses a geothermal energy system to: (i) drive the turbine to produce electricity from the electrical generator; (ii) drive the desalination plant which delivers the salt water supply from the salt water source, the ocean or salt water storage dam or tank; (ii) supply the distilled water to, and power, the hydrogen electrolyser; and (iv) power the nitrogen plant to harvest nitrogen from ambient air.

The disclosure uses a screw expander, turbine, ORC turbine, engine, steam engine or water wheel that converts energy from the fluid ammonia in the primary fluid circuit (thermal energy from the flowing fluid) into a mechanical output in the form of a rotary or piston force. This mechanical output can directly or indirectly drive a pump, or a compressor or alternatively can be used to drive the generator for electricity generation.

Additional comparisons with both wind and solar power shows geothermal energy to have a very small physical footprint, thus leaving surrounding land untouched, and available for alternative use. Additionally, this greatly reduces the environmental impact of the geothermal hydrogen production system as there is no requirement for power lines, clearing of trees, no emissions and no toxic waste produced and the land above and around the geothermal bore can be rehabilitated after installation. Geothermal desalination and pumping is also resistant to weather events and bush fire risk.

The present disclosure provides additional advantages in that there is minimal well or pump maintenance required, no power line maintenance or power losses through long distance transmission, and no solar panels to dust. The use of steam engines and steam expanders has a long life and a track record for proven reliability, known examples operating for up to 100 years.

Once drilled and installed a single geothermal well will produce for hundreds of years while the well head flow can be controlled remotely to adjust the pumping volumes achieved.

Geothermal desalination systems driven from single well geothermal energy systems using the thermal syphoning effect, do not produce the plastic waste that is normally generated by RO desalination plants. Additionally, these geothermal energy systems do not produce CO₂ emissions, do not produce toxic waste from the regular disposal of solar panels and wind turbine blades, do not require additional electricity generation and transmission, and have much lower negative impacts on the environment. It is calculated that a geothermal desalination system could produce fresh water up to 8 times cheaper than an RO desalination system whether driven from fossil fuel or electricity generated from solar, wind, or battery fed systems.

In some embodiments the turbine may be exchanged for one or more steam engines or screw expanders.

In some embodiments there is additionally provided at least one of an inlet or injection compressor to compress the fluid mixture entering the injection bore of the well; a nitrogen compressor to compress the nitrogen from the nitrogen plant before entering the receiver; and a hydrogen compressor to compress the hydrogen output form the electrolyser. Any one of more of the compressors may be powered from electricity generated from the electrical generator of the system.

The sub-surface geothermal ammonia production system of the disclosure may provide any one of more of the following advantages: zero emissions; reduced installation costs and maintenance costs; long usable life-span; comparatively small physical footprint (as compared to wind or solar); no toxic waste; and a reliable, steady long term energy supply.

In some embodiments, driving the turbine may be directly off the heated liquid of the primary fluid circuit. In some embodiments, driving the turbine may be off a secondary circuit in which heat from the heated fluid ammonia of the primary fluid circuit provides heat to a working medium of a secondary circuit to drive the turbine. Effecting heat transfer between the primary and the secondary circuits of some embodiments may be via a heat exchanger.

In some embodiments, the turbine may be substituted for one of a screw expander, a steam engine, and an ORC turbine. In some embodiments, the turbine may comprise a series of turbines. The saltwater source can be the ocean or a salt water dam or salt water bore, to provide a source of salt water to be delivered to the desalination plant.

As the working medium passes through the desalination plant, the thermal energy therein is used to distil the salt water (or sea water) in the desalination plant before the working medium is directed back to the heat exchanger to be reheated.

In some embodiments the secondary circuit may comprise a salt water condenser (or cooler) configured to draw heat from the secondary circuit to heat the salt water prior to supplying the desalination plant.

In a third aspect, the disclosure provides a method of sub-surface geothermal ammonia production, comprising the steps of: introducing a fluid mixture of hydrogen and nitrogen into an injection bore of a geothermal well, such that as the fluid mixture of hydrogen and nitrogen is drawn down the well it absorbs thermal energy from geology surrounding the well; exposing the heated fluid mixture of hydrogen and nitrogen to a catalyst within the well to initiate ammonia synthesis and create a heated fluid ammonia; drawing the heated fluid ammonia from a production bore of the geothermal well; and cooling the heated fluid ammonia.

In some embodiments, the method may comprise the step of driving the turbine directly off the heated fluid ammonia of the primary fluid circuit.

The method may comprise the step of driving the turbine off a secondary circuit in which heat from the heated liquid of the primary fluid circuit provides heat to a working medium of a secondary circuit to drive the turbine. Heat transfer between the primary and the secondary circuits of some embodiments may be effected via a heat exchanger.

In some embodiments, the method may further comprise the step of: drawing heat from the working medium of the secondary circuit via a salt water condenser to heat the salt water before delivering the salt water to the desalination plant. The working medium in the secondary circuit may be a binary fluid having a low-boiling point. The working medium may be N-Pentane.

In some embodiments, the method may further comprise the step of charging a primary fluid circuit with thermal energy from the heated fluid ammonia to thereby power a turbine to generate electricity and to distil salt water into distilled water within a desalination plant.

In some embodiments, the method may further comprise the step of communicating the distilled water to an electrolyser and powering the electrolyser with electricity generated by the turbine, to disassociate the distilled water and produce green hydrogen.

In some embodiments, the method may further comprise the step of combining the green hydrogen with a nitrogen source to feed the injection bore of the geothermal well to sustain ammonia synthesis within the well.

Various features, aspects, and advantages of the disclosure will become more apparent from the following description of embodiments of the disclosure, along with the accompanying drawings in which like numerals represent like components.

### BRIEF DESCRIPTION OF THE DRAWINGS

Embodiments of the disclosure are illustrated by way of example, and not by way of limitation, with reference to the accompanying drawings, of which:

FIG. 1 is a schematic view of a sub-surface geothermal ammonia production system comprising a single geothermal well delivering heated, pressurised ammonia from an outlet thereof;

FIG. 2 is a schematic view of a sub-surface geothermal ammonia production system comprising a plurality of injection and production bores within the geothermal well;

FIG. 3 is a schematic view of a sub-surface geothermal ammonia production system comprising a single geothermal well and a secondary circuit (Organic Rankine cycle-ORC) for indirectly powering a turbine and a desalination plant from the geothermally well;

FIG. 4 is a schematic view of a sub-surface geothermal ammonia production system comprising a secondary circuit, and a geothermal well comprising a single injection bore spaced apart from a single production bore, wherein the two bores are fluidly connected below ground;

FIG. 5 is a schematic view of a sub-surface geothermal ammonia production system comprising a secondary circuit, and a geothermal well comprising a single injection bore centrally located of a plurality of production bores wherein each of the five bores is fluidly connected below ground to deliver fluid ammonia to the primary fluid circuit;

FIG. 6 is a schematic view of a gas separator, illustrating a fluid supply comprising both liquid and gaseous factions being delivered to the separator, wherein liquid accumulates at the base of the separator to be tapped, and gases rise to be drawn off the top of separator; and

FIG. 7 is a flow chart illustrating the primary steps of the sub-surface geothermal ammonia production method, and the secondary processes powered or supplied by the primary steps for sustained ammonia production.

Embodiments will now be described more fully hereinafter with reference to the accompanying drawings, in which various embodiments, although not the only possible embodiments, of the disclosure are shown. The disclosure may be embodied in many different forms and should not be construed as being limited to the embodiments described below.

### DETAILED DESCRIPTION

A sub-surface geothermal ammonia production system and method for sub-surface geothermal ammonia production are described herein in relation to an MED desalination plant. However, it is contemplated that aspects of the disclosure can also be applied to a Reverse Osmosis (RO) desalination plant.

While the term “turbine” is used herein to describe a machine that produces mechanical work by passing a fluid flow over a rotor or impeller to impart rotational motion thereto, it is understood that the “turbine” can be substituted for other mechanical devices, such as a steam engine, an Organic Rankine Cycle (ORC) turbine or a screw expander. Those skilled in the art will appreciate that different expanders are suitable for different power ranges and applications.

The term “fluid” has been used herein to refer to the fluid of the primary fluid circuit, where it is understood that the fluid may contain both liquid and gaseous factions at different locations within the system due to the changing temperatures and pressures around the primary fluid circuit.

A secondary circuit is described to have a “working medium” where this medium is a fluid that circulates in a closed loop and is purely used as a working medium to transfer heat energy between the primary fluid circuit and the secondary circuit, and to subsequently disperse residual thermal energy to a number of outlets around the secondary circuit, ie. a second desalination plant and/or a secondary or ORC-turbine. The working medium can be a liquid or a gas with a low boiling point, for example N-Pentane.

The term “geothermal well” has been used herein to refer to a deep geothermal well transferring thermal energy from hot geology surrounding the well to the fluid within the well, to power the systems described herein. The terms “injection bore” and “production bore” have been used herein to refer respectively to the inlet channel and outlet channel of the well, which must be in fluid connection for any fluid to circulate within the well. It is understood, that the injection bore and production bore of the well may be coaxially located such that one bore is located within the other. It is further understood that the injection well and production bore may not be coaxially located and may be spaced apart from each other. It is further understood that a geothermal well may comprise one or more injection bores and one or more production bores, depending on the power requirements of the system.

The term “closed loop well” is understood herein to refer to a well where the volume of fluid entering the well is substantially equal to the volume of fluid exiting the well, ie the fluid circulating in the well is not lost to the surrounding well geology.

The term “green hydrogen” has been used herein to define a hydrogen product produced by renewable electricity. This is in contrast to brown hydrogen, which is produced from coal or lignite, grey hydrogen produced from natural gas such as methane (both of which release emissions in to the atmosphere) and blue hydrogen, which is also produced from natural gas (additionally capturing and sometimes storing released carbon). Using traditional means of production, green hydrogen typically costs twice as much as blue hydrogen.

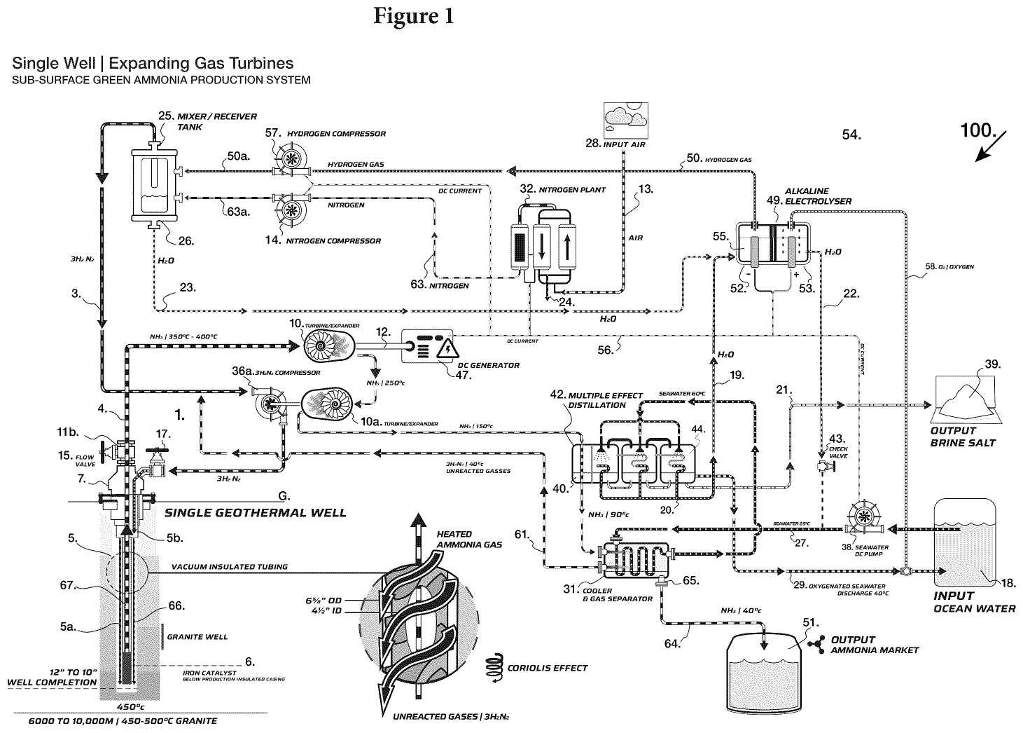

Illustrated in FIG. 1 is a sub-surface geothermal ammonia production system (100) comprising a single geothermal well (5) and an expanding gas turbine (10). The system (100) comprises
the geothermal well (5) having an inlet (11a) in fluid communication with an injection bore (5a), and an outlet (11b) in fluid communication with a production bore (5b), the inlet (11a) configured to receive a fluid mixture of hydrogen and nitrogen (3), and the outlet delivering a fluid ammonia (4); and a catalyst (6) disposed within the geothermal well (5), wherein the fluid mixture of hydrogen and nitrogen (3) is drawn into the injection bore (5a) of the geothermal well (5) absorbing thermal energy from geology surrounding the well (5) before entering the production bore (5b) of the geothermal well (5), whereby the heated fluid mixture of hydrogen and nitrogen (3) is forced into contact with the catalyst (6) to convert the fluid mixture of hydrogen and nitrogen (3) into the fluid ammonia (4). The catalyst (6) may contain iron.

At a depth where the temperature of the geology is 400° C. to 450° C., both the temperature and the natural static pressure are at ideal levels for the synthesis and chemical reaction in the presence of iron catalysts, to produce green ammonia (4). The fluid ammonia (4) is delivered to the well outlet (11b) at temperatures of about 350° C.-400° C. The heated fluid ammonia (4) is also pressurised to about 200 bar or 3,000 psi on delivery to well outlet (11b).

The well (5) of FIG. 1 is illustrated to have the production bore (5b) coaxially located with the injection bore (5a); however, it is contemplated that the arrangement could be reversed whereby the injection bore is located coaxially within the production bore. It is also contemplated that the injection bore and the production bore can be spaced apart from each other by a distance of 50 metres or more, without altering the functionality of the system (100) as described herein.

The granite well (5) drilled at this depth provides a safe pressure vessel with the capacity to withstand more than 20,000 psi, far higher than required for efficient ammonia production and located far away and below any potential exposure to personal and equipment that would normally be at risk from the hazards of hot pressure vessels typically installed on the surface or ground (G).

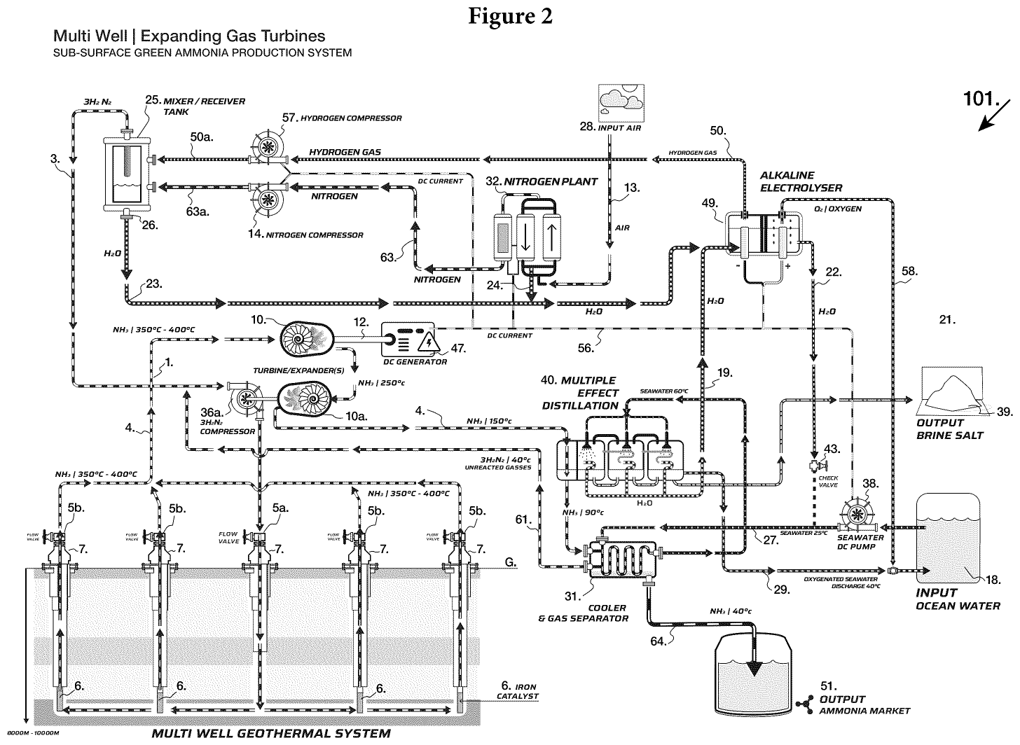

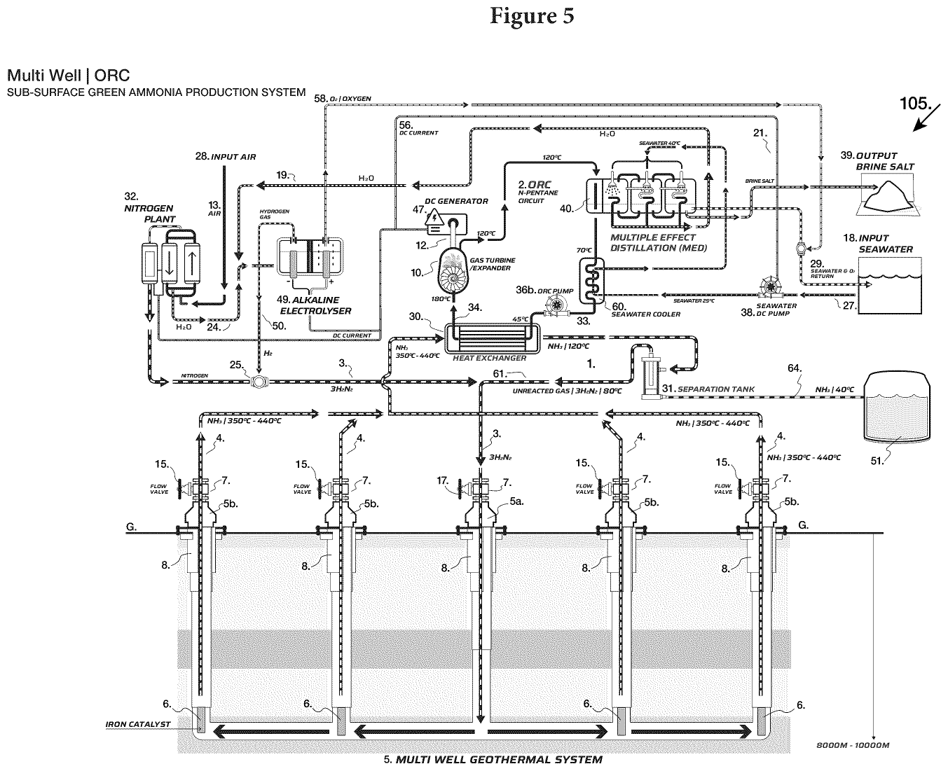

As the fluid mixture of hydrogen and nitrogen (3) is heated and converted to ammonia (4), the thermal syphoning effect pushes the ammonia (4) to the surface (G) either inside of an insulated inner casing, illustrated in FIG. 1 as a vacuum insulated tubing (VIT) (67) if producing in a “closed loop” single well, or up one to four connected production bores (5b as illustrated in FIGS. 2 and 5). The multi-bore systems of FIGS. 2 and 5 have no requirement for VIT (67) where the fluid ammonia is being produced from a multi well ‘closed loop’ system.

As illustrated in FIG. 1, the iron catalyst (6) can be installed within an outer casing (66) of the well (5). And can be located below the VIT (67) at the inlet to the production bore (5b) thereby ensuring a substantial portion of the heated fluid mixture of hydrogen and nitrogen (3) is exposed to the catalyst (6). The catalyst (6) can be localised in some embodiments, and in others can have a length of more than 2 km providing far greater exposure to the fluid mixture of hydrogen and nitrogen (3) gas to be converted into ammonia (4) than can be practically installed on the surface.

As the green ammonia (4) is pushed to the surface (G), a small amount of heat or thermal energy is lost from the heated fluid ammonia (4) into shallower geology surrounding the production bore of the well. At the surface (G), the temperature of the green ammonia (4) will be about 20° C. less than the temperature of the green ammonia at the bottom of the well (5); and at the surface of a multi well system, the temperature will be in the range of 30° C. to 50° C. less than the bottom-hole temperature of the well (5).

Once pushed to the surface (G) by the thermal syphoning effect, the fluid ammonia (4) contains thermal energy that must be extracted so that the fluid ammonia (4) in a gaseous state can be converted (condensed and cooled) into fluid ammonia (4) in a liquid state, and any unprocessed or unreacted gasses can be reinjected for further refining to produce more ammonia (4).

The heat that is extracted from the 350° C. to 400° C. fluid ammonia (4) is circulated in a primary fluid circuit (1), where the fluid flow is used to drive a turbine (10) to produce a mechanical output (12) which powers an electrical generator (47). The generator (47) generates electricity which is transmitted around the system (100) via cables (56) to power other components of the system (100).

The geothermal well (5) requires bottom-hole geology temperatures of about 350° C.-500° C. to provide the optimum temperature for the synthesis of ammonia process and to provide sufficient thermal energy to power the ammonia production system (100). However, one or more flash tanks can be integrated into the primary fluid circuit (1) to increase the temperature or vapour content of the fluid ammonia (4) in the primary circuit to drive the turbine (10)—these flash tanks or flash separators are not illustrated in FIG. 1.

Although not illustrated in FIG. 1, in some embodiments of the system (100) water can be injected into the injection bore/s (5a) of the well (5) with the fluid mixture of hydrogen and nitrogen (3). The presence of water will increase the bottom-hole pressure which can be beneficial to the ammonia production process and efficiencies thereof. The water injected will heat with the fluid mixture of hydrogen and nitrogen and increase the pressure of the environment for synthesis, where typical ammonia production levels are about 30% of the total gasses.

Increasing pressure improves the ammonia production level (above 30%) more than increasing the temperature above 450° C. As such, the introduction of water into the injection well is a more efficient way to increase the pressure at the bottom of the well to desirable pressures of about 200 Bar (or more).

Without water injection, to increase the bottom-hole pressure (having gas only in the well), the fluid mixture of hydrogen and nitrogen being injected into the well may need to be compressed in combination with restricting the well outlet (the production well), to maintain the desirable 200 Bar, or more, at the bottom of the well. Due to the elevation of the well, there will be a greater pressure at the bottom of the well (full of fluid only), than the pressure at the surface: for example, to maintain a bottom-hole pressure of 200 Bar it is calculated that the fluid mixture of hydrogen and nitrogen will need to be compressed to about 100 Bar on injection.

To accommodate for the presence of water in the fluid ammonia (4) delivered to the primary fluid circuit (1) from the production bore (5b) of the well (5), the system (100) will additionally require a means for removing the water in fluid and/or gaseous form from the fluid ammonia (4) before collection and storage. It is contemplated that a separator can be incorporated into the primary fluid circuit (1) to separate the fluid ammonia (4) from the water and from any un-reacted gasses. Types of separator (37), cooler (31) and cooler+separator (31) are described in more detail herein. The addition of water to the fluid mixture of hydrogen and nitrogen (3) can be utilised in any one or more of the systems (100, 101, 102, 103, 104) as described herein and is not limited to system (100) as described above.

### Flashing

As the fluid in the primary circuit (1) emerges from the outlet (11b) of a well head (7) at between 350° C.-400° C., the flash separator can be used to increase the temperature of the fluid ammonia (4) and provide additional vapour to drive the turbine (10).

It is further contemplated that several stages of flash separator (also referred to as flash tanks) can be configured to provide for additional energy to be harvested. This additional energy can be directed to additional turbines or additional compressors to drive/power other components of the system. In some arrangements a series of flash separators can be interlinked with the exhaust products of each separator driving a single turbine (10), alternatively the products of each separator can be individually channelled to drive a series of turbines/expanders.

The pressure within the separator decreases when heated fluid ammonia (4) is drawn into the flash separator or separator. This drop in pressure forces a portion of the heated fluid ammonia (4) to vaporise. The vapour is then communicated to the turbine (10) where the flow of vapour drives the turbine (10) or engine to produce the mechanical output (12) schematically illustrated in FIG. 1 as a shaft that is rotated. The mechanical output (12) as movement of the shaft is then transmitted to the electrical generator (47). In this manner, at least a portion of the thermal energy drawn from the geology of the well (5) is used to drive the electrical compressor (47) connected to the turbine (10).

When introducing the heated fluid ammonia (4) to the separator the heated fluid (4) enters the separator typically via a throttling valve reducing the pressure of the heated fluid ammonia (4) to initiate flash evaporation. A portion of the fluid ammonia (4) immediately “flashes” into vapour. The vapour is then draw-off the top of the separator to drive the turbine (10).

After flashing, the un-flashed fluid or residual heated fluid of the primary fluid circuit (1) exits the separator via an outlet or drain. Simultaneously, the vapour (6) exits the turbine (10) as exhaust which has decreased in temperature. The residual heated fluid may be mixed with the exhaust of the turbine (10) to bring the temperature back-up before being directed to a secondary flash separator or an MED desalination plant (40).

After passing through the turbine (10) the fluid ammonia (4) is reduced in temperature to about 250° C. There is sufficient thermal energy in the ammonia (4) of the primary fluid circuit (1) to power the MED desalination plant (40). The MED plant (40) is delivered salt water (16) from a salt water source (18) which is sprayed into chambers of the MED plant (40) from a first chamber (42) to a last chamber (44).

The heated fluid ammonia (4) is communicated to the first chamber (42) of the desalination plant (40) to evaporate the salt water (16) introduced thereto. The thermal energy is drawn from the fluid ammonia (4), cooling the ammonia (4) and evaporating the salt water (16) producing a distilled water (20) which is outputted from the MED plant (40) and routed to an alkaline hydrogen electrolyser (47). The salt water (16) can be pumped from the salt water source (18) by a salt water pump (38) driven from the electricity generated by the generator (47).

As illustrated in FIG. 1, the desalination plant (40) has two main outlet lines: (i) distilled water outlet line (19); and (ii) brine outlet line (21). The brine outlet line (21) directs brine (39) away from the plant (40) as the desalination plant (40) continues to process sea or salt water (16). The distilled-water outlet line (19) directs distilled water (20) to the electrolyser (49) to maintain the reaction in the electrolyser to continuously create hydrogen therein.

As the fluid ammonia (4) exits the desalination plant (40), the fluid ammonia (4) is at a temperature of about 90° C. To further cool the fluid ammonia (4), the exhaust from the desalination plant (40) can be directed to a cooler (31) to reduce the fluid ammonia to about 40° C. for collection in storage tank (51). The cooled fluid ammonia (4) is exhausted from the cooler (31) into an ammonia outlet line (64) to supply the storage tank (51). The tank (51) can be static or could be a transport vehicle for distribution of the ammonia (4).

The cooler (31) is charged with salt water (16) from the salt water source (18), such that the salt water (16) absorbs thermal energy from the fluid ammonia (4) reducing the temperature of the ammonia (4) and increasing the temperature of the salt water (16). The salt water (16) is pumped via salt water pump (38) along salt water feed line (27) to the cooler (31) and the heated salt water (16) is delivered to the chambers of the desalination plant (40), where the increased temperature of the salt water (16) increase the efficiency of the MED plant (40). Any residual salt water (16) is returned via salt water return line (29) to the salt water source (18).

Salt brine (39) is formed as a bi-product of the desalination process within the plant (40). The salt brine (39) is outputted via the brine outlet line (21) and can be collected for sale or commercial use.

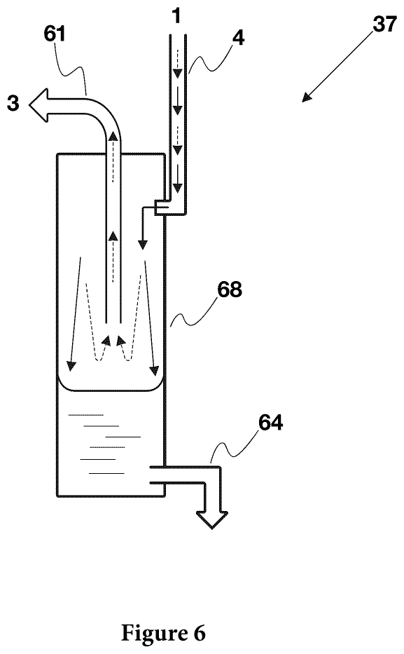

The cooler (31) can be configured as a combination cooler and gas separator, wherein the unreacted nitrogen and hydrogen gases within the fluid ammonia (4) of the primary fluid circuit (1) are extracted and redirected along a redirection line (61) to be reinjected into the well (5). The fluid ammonia (4) in liquid form gathers at a bottom of the cooler/separator where it is drawn-off to the storage tank (51) while the hot unreacted gases rise in the cooler (31) to enter the redirection line (61). A schematic view of a separator (37) is illustrated in FIG. 6.

The desirable feed temperature to the cooler+separator (31) is around 90° C. This is compared to the desirable feed temperature for the desalination plant (40) which is about 150° C., wherein the exhausted fluid ammonia (4) in the primary fluid circuit (1) exiting the desalination plant can then be fed to the cooler+separator (31) for further heat extraction.

### Hydrogen Electrolyser

FIG. 1 illustrates the sub-surface geothermal ammonia production system (100), comprising the desalination plant (40) and the electrolyser (49) configured as a hydrogen electrolyser, driven by the electrical output from the electrical generator (47).

Electrical power from the generator (47) is transferred via cable/s (56) to a cathode (52) and an anode (53) of the electrolyser to set-up an electrical circuit. The electrical circuit transfers electrons from a first, anode, side of the electrolyser (49) to a second, cathode, side of the electrolyser (49).

The two sides of the electrolyser (49) are separated by a diaphragm (54), which along with the anode and cathode, is submersed in electrolyte solution (55) to complete the electrolyser (or electrolysis cell).

As the circuit of the electrolyser (49) is energised, the electrolyte solution (55) which here is distilled water, reacts around the anode (53) producing hydrogen ions (protons) with a positive charge, electrons (with a negative charge) and also oxygen (O). The oxygen can be drawn off the electrolyser (49) via an oxygen line (58) and collected for sale, or reintroduced back into the salt water source (18).

In a polymer electrolyte membrane electrolyser (a PEM electrolyser), the diaphragm (54) separating the two sides of the cell is a solid, plastic material. As the water is split on the anode (53) side, the protons migrate across the diaphragm towards the cathode (52). At the same time, the electrons flow in the electrical circuit from the anode to the cathode, whereupon the protons combine with the electrons at the cathode (52) to produce hydrogen. The hydrogen is drawn from the electrolyser (49) into a hydrogen line (50) and directed to a receiver (25) illustrated in FIG. 1 as a mixing tank.

The reactions on either side of the electrolyser (49) can be written as:

Anode Reaction: 2H2O→O2+4H⁺+4e⁻

Cathode Reaction: 4H⁺+4e⁻→2H2

It is contemplated that other types of electrolyser (49) could be driven from the systems (100, 101) described herein: for example, solid oxide electrolysers or alkaline electrolysers.

As shown in FIG. 1, the electrolyte solution (55) is constantly topped-up with fresh water (20) from the desalination plant (40) to sustain the hydrogen producing reaction in the electrolyser (49). Unreacted electrolyte solution (55) can be drawn off into an unreacted water line (22) and directed back to the salt water feed line (27) suppling the cooler (31). The unreacted water line (22) can provide a check valve (43) to control the release of unreacted water back into the salt water feed line (27).

The hydrogen produced by the electrolyser (49) is communicated via the hydrogen line (50) to the receiver (25). The hydrogen can also be compressed by a hydrogen compressor (57) to provide a compressed hydrogen (50a) to the receiver (25). The hydrogen compressor (57) is electrically connected by cable (56) to be driven from electricity generated by the generator (47).

The electrical generator (47) preferably generates a DC current and delivers this directly to the cathode (52), negative terminal, and/or anode (53), positive terminal, of the electrolyser (49). The electrical generator (47) is also used to power a nitrogen plant (32). The nitrogen plant (32) configured to draw-in ambient air (28) via an air intake line (13). The ambient air (28) is processed or filtered to separate nitrogen from the air (28) to supply a nitrogen feed line (63).

Within the nitrogen plant (32) air is forced through a filter to separate nitrogen and oxygen from the air intake line (13) (the series of filters and nitrogen compressor are not shown in FIGS. 1-5) providing a source of nitrogen to nitrogen line (63). The nitrogen can be compressed within the plant (32) or compressed after leaving the plant (32). The compression process can heat the nitrogen to about 300° C.-600° C. before being delivered to the receiver (25).

The nitrogen plant (32) will also exhaust oxygen from the ambient air (28) drawn therethrough. The oxygen from the nitrogen plant (32) can be combined with the oxygen (58) drawn from the electrolyser (49) and either stored, sold or reintroduced into the salt water source (18) to re-oxygenate and reinvigorate the environment. This can boost the oxygen levels in the sea or salt water source (18) and support the local flora and fauna.

The nitrogen from the nitrogen plant (32) is communicated via the nitrogen line (63) to the receiver (25). The nitrogen can be compressed externally of the plant (32) by a nitrogen compressor (14) to provide a compressed hydrogen (63a) to the receiver (25). The nitrogen compressor (14) is electrically connected by cable/s (56) to be driven from electricity generated by the generator (47).

Within the receiver (25) the compressed hydrogen (50a) and compressed nitrogen (63a) are mixed together before being fed to the injection bore (5a) of the geothermal well (5). An additional inlet compressor (36a) can be configured to further compress the fluid mixture of hydrogen and nitrogen (3) before introduction to the well inlet (11a). Prior to or immediately prior to the inlet compressor (36a) is an opportune located to reinject the unreacted gases from the cooler/separator (31) via the redirection line (61).

During the mixing process within the receiver (25) residual water within the compressed gases (50a) and (63a) can accumulate. The residual water can be bled from a receiver drain (26). The residual water can then be fed via residual water line (23) back to the electrolyser (49) as an electrolyte solution (55) top-up source.

The inlet compressor (36a) can also be driven-off the thermal energy of the primary fluid circuit (1) by introducing a second turbine (10a). The second turbine is configured to receive the exhausted fluid ammonia (4) from the first turbine (10) at temperatures of about 250° C. After passing through the second turbine (10a) the fluid ammonia (4) is reduced again in temperature to about 150° C., still charged with sufficient thermal energy to supply the desalination plant (40).

The primary fluid circuit (1) can further comprise a start-up pump (not illustrated) to initiate or supplement circulation of the fluid ammonia (4) around the primary fluid circuit (1). The start-up pump can be powered from the electricity generated from the electrical generator (47). However, once the primary fluid circuit (1) is operational, the thermal syphoning effect is sufficient to sustain fluid flow therein. As such, the start-up pump is not required to maintain operation of the system (100).

Each of the compressors of the system: the inlet compressor (36a), the hydrogen compressor (57) and the nitrogen compressor (14) can be selected from either screw compressors or piston compressors, where a screw compressor will be better suited to a large volume of fluid under lower pressure and a piston compressor will be better suited to larger pressures with less volume.

### Salt Water Source

The system (100) can be installed inland to utilise the large supplies of salt water or on the coast to use sea water (18) as a source for desalination. The salt water can be supplied from damns, or from salt water bores depending on the location of the system (100). The cost of producing distilled water in all of these locations, including maintenance, equipment depreciation, wages and admin costs is calculated to be about AUD$0.20c per KL. Compared to RO desalination that costs about A$2.20 per KL for a lower quality water product and produces large amounts of CO2 and plastic waste; geothermal desalination by MED is much cheaper and produces no waste plastic or CO2 emissions. The well/s (5) will produce thermal energy for hundreds of years and the low cost surface equipment will require minimal maintenance, and routine replacement about every thirty years.

### Geothermal Well

The depths of the well (5) can be between 3,000 m to 12,000 m depending on the geology and the thermal energy required.

The geothermal well (5) comprises at least one injection bore (5a) and at least one production bore (5b) connected, but spaced apart from one another. Alternatively, the injection bore (5a) and the production bore (5b) of the well can be coaxially located such that one is encircled or encased within the other.

In some embodiments the geothermal well (5) comprises a plurality of injections bores (5a) and production bores (5b) to supply the thermal energy required by the system. In some embodiments, a plurality or array of geothermal wells (5) is arranged to supply the thermal energy needs of the system, each well comprising one or more production bores and one or more injection bores.

Each bore of the well (5) provides a well head (7) illustrated in FIGS. 1-5. Each well head (7) provides either the well inlet (11a) or the well outlet (11b). Each inlet (11a) has an inlet flow valve (17), and each outlet (11b) has an outlet flow valve (15). Each well head (7) can also comprise a number of internal seals (46) to withstand the high pressures generated therein.

The well heads (7) provide a means for circulating the fluid mixture of hydrogen and nitrogen (3) into the injection bore (inlet channel) (5a) to be heated in the well (5) and return the heated fluid ammonia (4) to the surface (G) via the production bore (outlet channel) (5b). The heated fluid ammonia (4) is driven up the production bore (5b) to the outlet (11b) by the thermal syphoning effect as the cooler fluid mixture (3) continues to be drawn into the injection bore (5a).

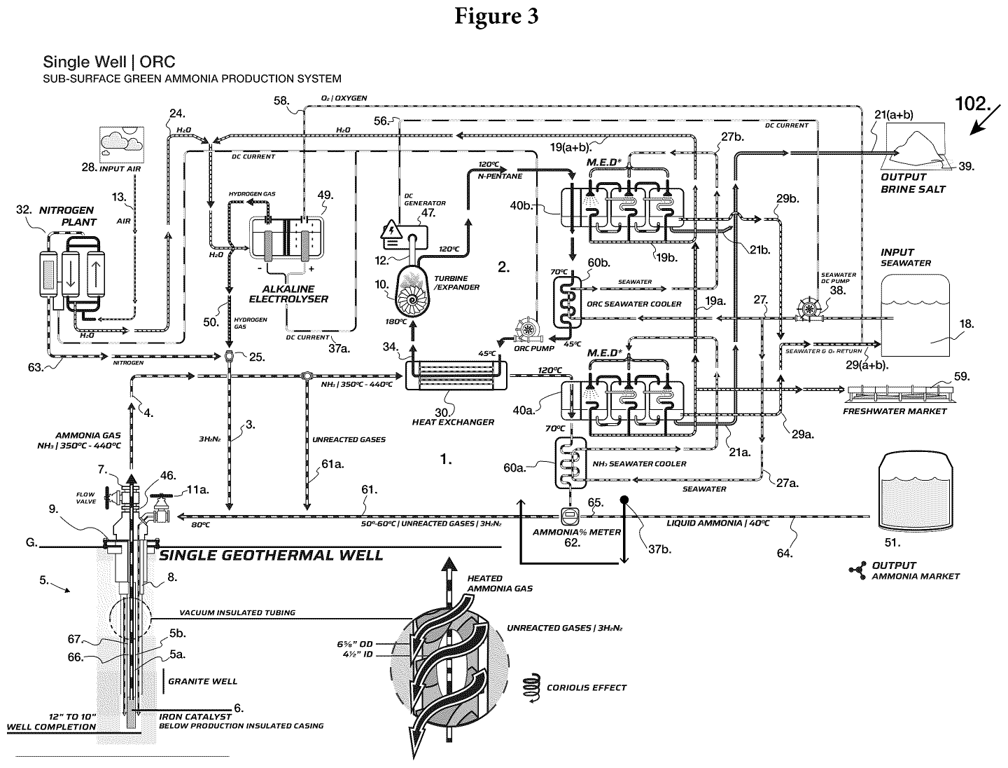

The production bore (5b) is defined by an insulated casing illustrated in FIG. 3 as the vacuum insulated tubing (VIT) (67). The VIT (67) can have an inner diameter of about 4½″ and an outer diameter of about 6⅝″.

Where the production bore (5b) and injection bore (5a) are coaxially located, the production bore (5b) as defined by the VIT (67) can be circular and can be circumferentially bounded by the injection bore (5a). The injection bore (5a) is thus annular in shape and insulates the heated fluid ammonia (4) as it travels up the production bore (5b) to the outlet (11b).

The injection bore (5a) can be defined by the outer casing (66) which encircles the bore (5a) from the surrounding geology. Alternatively, outer walls of the injection bore (5a) can be defined by the surrounding geology of the well (5).

The well head (7) can comprise one or more collars (9) for supporting the well (5) at the surface. The well (5) can comprise one or more insulated casings (8) extending from the surface (G) to predetermined depths within the well (5) thereby providing: a barrier to the surrounding geology; structural support to the well; and insulating layer/s.

In some embodiments, the injection bore (5a) extends axially into the ground to a depth of approximately 6,000 m-12,000 m. The exterior of the well (5) as defined by the outer casing (66) extends to the bottom of the well (5), closing the well (5) to the surrounding geology. This “closed-well” or sealed well arrangement prevents contact between the fluid of the primary fluid circuit (1) and the geology surrounding the well (5). This “closed well” arrangement prevents sediment and other geological impurities from entering the fluid mixture of nitrogen and hydrogen (3) of the primary fluid circuit (1).

The thermal syphoning effect pushes the heated fluid ammonia (4) up the production bore (5b) inside of the VIT (67). The fluid mixture (3) is heated as it passes through the lower layers of the surrounding geology. The slower the fluid flows down the injection bore (5a), the more heat will be transferred from the geology into the injected fluid mixture (3).

Approximately 20° C. is lost from the ammonia fluid between a bottom of the well (5) and the outlet (11b) but this heat is not lost totally, as it is transferred into the inlet channel (5a) and surrounding casings (8) and increases the heating rate of the inlet channel (5a).

The well (5) with a bottom-hole rock or geology temperature of 350° C. to 500° C. can have a thermal energy output of between 10 MW-30 MW, for example 23 MWth (thermal megawatts) with a flow rate from the well head (7) of 20 Kg per second and output temperature of about 350° C. with an injection temperature of about 80° C.

Thermal syphoning moves the fluid mixture of nitrogen and hydrogen (3) within the well (5) once the circuit (1) begins flowing. In some embodiments, the hydrogen and nitrogen fluid mixture entering the injection bore (5a) is at about 80° C. As the fluid mixture is drawn down the well (5) it is heated on its journey to the bottom of the well (5) and then pushed to the surface at the well head (7). The increased temperature and the pressure created from the heat forces the heated fluid up the production bore (5b) to the surface to exit the well head (7) at a temperature of about 300° C.-400° C. and a pressure of about 200 to 400 Bar depending on the adjustment (restriction) of production flow from the well head outlet (11b).

While the heated fluid ammonia (4) may experience heat loss on the journey up the well (5), a temperature of the production bore outlet (11b) will typically be about 5% less than the temperature of the fluid at the bottom of the well (5).

In one particular embodiment (as shown in FIG. 2), the geothermal well (5) is a five bore system, with one injection bore (5a) and four production bores (5b). In this arrangement the maximum flow volume through the well (5) will be limited by the volume capacity of the single injection bore (5a). The fluid mixture of hydrogen and nitrogen (3) entering via the injection bore (5a) will be communicated substantially evenly to each of the four production bores (5b). Total thermal energy production (extraction) of the embodiment from a flow rate of about 80 kg/second is calculated to be around and 92 MW of thermal energy per hour.

The well (5) can be configured for a few thousand metres up to about 12,000 m into almost any geology, including granite. The geothermal heat is exchanged at depth via the closed-loop system rather than bringing deep geothermal brine to the surface. This form of well (5) has a production life of 100+ years, with relatively low maintenance costs. The well (5) has a small physical footprint and has minimal impact on surface ground water systems, as the layers of casings around the well (5) provide protection.

The depth of the well (5) required for any given sub-surface geothermal ammonia production system (100, 101, 102, 103, 104) will depend on the geology of the area. The well depth can be tailored to provide the requisite thermal energy required to feed the turbine (10), before being introduced to the desalination plant (40).

### Catalyst

In order to improve ammonia synthesis a catalyst (6) can be used. The catalyst (6) is or at least contains/comprises iron.

The catalyst (6) can be confined to at least one of the injection bore (5a) and the production bore (5b). In some embodiments, it is anticipated that the catalyst (6) will be located at the juncture between the injection bore (5a) and the production bore (5b).

The catalyst (6) can be localised, as illustrated in FIG. 1 below the VIT (67) of the production bore (5b). This location for the catalyst (6) maximises the exposure between the heated fluid mixture of hydrogen and nitrogen (3) to minimise the amount of unreacted nitrogen and hydrogen gas in the fluid ammonia (4) delivered to the well outlet (11b).

It is anticipated, that the catalysts (6) can be located along a long stretch of the production bore (5b) extending in excess of 1000 metres, to provide a larger capacity catalyst (6) surface over which to react the heated fluid mixture of hydrogen and nitrogen (3).

The catalyst (6) can be inserted into the well (5) in solid form or as a liner to the VIT (67). It can be suspended by wire rope of other suspension system. It is further contemplated that the catalyst (6) can be in particulate form to maximise surface area thereof.

The catalyst (6) can be suspended within the well (5) in open cages, such that the heated fluid mixture of hydrogen and nitrogen is forced through the particulate catalyst (6) within the open cages on the journey to the well outlet (11b). Having the particulate catalyst (6) with a cage structure further facilitates removal and/or replacement of the catalysts (6). In one embodiment it is anticipated that the cages containing the catalyst (6) can be suspended by cables within the production bore (5b) of the well (5) to be drawn up and down the well (5) as and when required.

As the fluid mixture of hydrogen and nitrogen (3) is drawn into the injection bore (5a) of the well (5) the fluid mixture will encircle the bore under the Coriolis Effect. This spiralling motion of the fluid mixture (3) will assist in gaining contact and exposure between the fluid mixture (3) and the catalyst (6) to encourage efficient ammonia synthesis.

Before moving to FIG. 2, a brief overview of the internal workings of a typical desalination plant is provided.

### Multi-Effect Distillation (MED) Plants

An MED plant uses distillation to desalinate sea or salt water. In each “effect” or “stage” of the multi effect distillation or MED plant (40), salt water (16) is sprayed onto tubes or plants heated by thermal energy inside of the tubes or plate heat exchangers that are position inside of the MED chambers. Some of the salt water evaporates, and this fresh vapour is directed into the next chamber of the MED plant to be sprayed onto the tubes or plates in the next chamber and so on until this process has been replicated between three and seven times in three to seven MED chambers of the MED plant with increasing vacuum or decreasing atmosphere pressure in each chamber, heating and evaporating more fresh water from salt water. Thus each stage reuses energy from the previous stage, with successively lower temperatures and pressures.

The MED plant (40) comprises a sequence of closed chambers separated by walls, having a hot fluid or steam heat source at a first chamber the same fluid with reduced heat (condensed) exiting from the first chamber. Each successive chamber has a temperature and a pressure lower than a previous chamber. This means the walls within each chamber are held at a temperature intermediate the temperatures of the fluids on either side thereof. This temperature differential, coupled with a pressure drop in the chamber, transfers evaporation energy from a warmer first zone of the chamber to a colder second zone of the chamber. From the second zone the heat energy then travels via conduction (and/or piping) through the wall to the colder subsequent chamber. Additional salt water can also be sprayed into the subsequent chambers to continue the effect through each chamber of the plant (40).

The primary fluid circuit (1) of the system (100) is routed through the first chamber (42) of the MED plant (40) after being expelled from the turbine (10). In this manner the heat energy in the primary fluid circuit (1) is used to supply heat to the MED plant (40) before the heated fluid ammonia (2NH3) (4), is drawn from the system (100) for storage or transport.

The heated ammonia fluid (4) enters the first chamber (42) of the MED plant (40) at about 150° C. On exiting the first chamber (42) of the plant (40) which has an ambient temperature of about 60° C. to 90° C., salt water or sea water is sprayed onto the internal pipes or plates of the primary fluid circuit (1) communicating the fluid ammonia (4) through the MED plant (40) to reduce the temperature thereof to about 90° C. before being drawn through the cooler (31) to further reduce the temperature of the fluid ammonia to about 40° C.

The temperature in the first chamber (42) of the plant (40) is about 70° C., and drops by about 5° C. in each subsequent chamber. The temperature in a final chamber (44) is about 45° C. in a five chamber MED system. The MED plant (40) can comprise fewer or additional chambers, depending on the quantity of the salt water delivered to the MED plant and the required quality of the fresh water (20) delivered from the MED plant (40).

The salt water supply pump (38) is capable of pumping sea or salt water (16) along the salt water delivery line (27) for distances of up to 10 kms (and more) from the ocean, water store or salt water bore to the MED plant (40). At the termination of the delivery line (27) the salt water (16) is sprayed into the chambers of the plant (40). The temperature of the salt water (16) introduced into the MED plant (40) can be elevated to about 60° C. after passing through the cooler (configured as a form of heat exchanger) (31) to further cool (draw thermal energy from) the fluid ammonia (4) prior to its collection in tank (51).

It is calculated that for every million litres of salt water delivered to the MED plant (40) approximately 400,000 litres of distilled fresh water (20) can be drawn from distilled water outlet line (19) without any CO2 emissions, toxic waste or additional electricity load input and at an operational cost per KL of around 8 times lower than typical RO desalination costs per KL.

Although not illustrated in the Figures, the salt water source (18) can comprise a plurality of salt water bores all feeding the single delivery line (27) or a large salt water source supplying a plurality of delivery lines (27) to subsequently feed one or more desalination plants (40).

The brine outlet line (21) discharges the accumulated salt brine as a residual or waste product of the desalination system (100). However, this salt brine can be used for downstream processes, or harvested for desirable commercial properties. The salt brine can be evaporated to produce salt, pot ash, magnesium, lithium and other minerals at very low cost compared to current mining process for these minerals. These products can be sold to farmers for fertilising requirements and to the public for consumption and a wide range of other requirements. In some locations, local crops such as wheat and barley can be used to produce PLA at low cost. Using some of the waste heat from this geothermal MED system, PLA can be produced from locally grown crops at very low cost. This product can be exported and can generate environmentally friendly, plant based plastic production business opportunities.

Turning now to FIG. 2, there is illustrated a sub-surface geothermal ammonia production system (101) comprising the same features as described herein in relation to system (100). However, system (101) is configured to draw thermal energy from a plurality of bores (5a, 5b) which together form the geothermal well (5) supplying fluid ammonia (4) to the primary fluid circuit (1).

The well (5) comprises a single injection bore (5a) and four production bores (5b) arranged in series, with the injection bore (5a) located centrally of the series. Each of the four production bores (5b) comprises a catalyst (6) as described herein in reference to FIG. 1. Each bore of the well (5) is in fluid communication with the remaining bores, such that the fluid mixture of nitrogen and hydrogen (3) entering the well (5) from the inlet (11a) of the injection bore (5a) is separated and directed in substantially equal portions to each of the four production bores (5b).

In some embodiments, the well (5) can comprise more than one injection well (5a) and more or less than four production bores (5b) depending on the thermal output required from the system (101).

The one or more injection bores (5a) will each have an inlet flow valve (17) to regulate and control the flow volume of the fluid mixture of hydrogen and nitrogen (3) entering the well (5). The one or more production bores (5b) will each have an outlet flow valve (15) to regulate and control the flow volume and pressure of the heated fluid ammonia (4) exiting the well (5).

### Organic Rankine Cycle (ORC)

Turning now to FIG. 3, there is illustrated a sub-surface geothermal ammonia production system (102) comprising an ORC or secondary fluid circuit (2). The system (102) requires no electricity supply and also uses the thermal syphoning effect for energy requirements to maintain the primary fluid circuit (1) and to deliver salt water (16) to the desalination plant (40).

With this zero electricity ammonia production system (101), it is possible to drive the electrical generator (47) from the turbine (10) which is now powered by the secondary fluid circuit (2) and not the primary fluid circuit (1) as described in relation to systems (100, 101).

A first desalination plant (40a) is supplied with thermal energy contained within the fluid ammonia (4) within the primary fluid circuit (1), while a second desalination plant (40b) is supplied with thermal energy from the secondary fluid circuit (2).

Typically, the desalination plant (40a) will take around 20° C. off the temperature of the heating or primary fluid circuit (1) as it passes through the first chamber (42) of the MED plant (40a). The larger the capacity of the MED plant (40a) the more heat required from the primary fluid circuit (1). Conversely, the smaller the capacity of the MED plant (40a), the less heat required from the primary fluid circuit (1).

The thermal energy from the primary fluid circuit (1) is extracted from the 350° C. to 400° C. fluid ammonia (4) through a heat exchanger (30) to drive an ORC electricity generation system. A working medium (33) in the ORC system or secondary circuit (2) is heated by the heat exchanger (30) charged by the primary fluid circuit (1) heated directed from the well (5). The working medium (33) is heated to become a heated working medium (34) at least partially in gaseous form where it can then drive a turbine (10), which powers an AC or DC electrical generator (47).

The secondary fluid circuit (2) includes an ORC pump or circuit pump (36b), that drives circulation of the working medium (33) within the secondary circuit (2). The secondary circuit (2) can use a working medium that has a low boiling point such as N-Pentane. The circuit pump (36b) is driven by electricity from the electrical generator (47) fed through cables (56). The circuit pump (36b) keeps the working medium (33) flowing around the secondary circuit (2), to continually draw cooler working medium (33) through the heat exchanger (30). Heat energy from the heated fluid ammonia (4) in the primary fluid circuit (1) is transferred to the working medium (33) via the heat exchanger (30) heating/vaporising the working medium (34) to a gaseous form to drive the turbine (10) to create the mechanical output (12) and power the electrical generator (47). No flash separator is required in the primary fluid circuit (1) as the heat exchanger (30) provides the additional heat energy to convert the working medium (33) to heated working medium (34) in gas or vapour form to drive the turbine (10).

The heated fluid ammonia (4) of the primary fluid circuit (1) after exiting the heat exchanger (30) continues to the first MED plant (40a) as described above in relation to system (100). On exiting the MED plant (40a) the heated fluid ammonia (4) is communicated to a cooler in the form of a salt water cooler or condenser (60a). The first salt water condenser (60a) draws thermal energy from the heated fluid ammonia (4) to heat the salt water (16) from the salt water source (18) before being supplied to the first desalination plant (40a). The salt water cooler (60a) similar to the cooler (31) of system (100) is charged with salt water (16) drawn from the salt water source (18) to cool the fluid ammonia (4) before it is exhausted to the ammonia outlet line (64) to be collected in tank (51).

Also shown in FIG. 3, the system (102) provides a salt water cooling system for the secondary circuit (2). The cooling system is provided in the form of a second salt water condenser (60b). The second salt water condenser (60b) draws thermal energy from the heated working medium (34) to cool the working medium of the secondary circuit (2) and heat the salt water (16) from the salt water source (18) before being supplied to the second desalination plant (40b).

FIG. 3 additionally illustrates an ammonia meter (62) for separating unreacted gasses from the fluid ammonia (4) and for measuring the volume of ammonia produced by the system (102). The ammonia meter (62) can be incorporated into any of the systems (100, 101, 102, 103, 104) as described herein.

In some embodiments, DC current is generated and this electricity will provide the necessary green electricity to power the alkaline hydrogen electrolyser (49).

The heated working medium (34) of the secondary circuit (2) exiting the turbine (10) requires condensing and cooling so that it can be pumped in liquid form at approximately 80° C., through the heat exchanger (30) again to be heated and converted to gas. One way to cool and condense the heated working medium (34) back into a liquid state, is to direct the heated working medium (34) exhausted from the turbine (10) into the second MED desalination plant (40b), which requires a heat source of between 80° C. and 110° C. which is within the temperature range of the heated working medium (34) exhausted from the turbine (10).

Each of the MED plants (40a, 40b) can be supplied from the same salt water source (18) via the salt water supply line (27). The supply line (27) is split to be communicated to a first seawater cooler (60a) from supply line (27a) and a second seawater cooler (60b) from supply line (27b). The salt water coolers (configured as heat exchangers) (60a, 60b) reduce the respective temperatures of the fluid ammonia (4) in the primary fluid circuit (1) and the working medium of the secondary fluid circuit (2), thereby heating the salt water (16) supplied to each of the desalination plants (40a, 40b).

Seawater cooler (configured as a heat exchanger/condenser) (60b) removes thermal energy from the heated working medium (34) to sustain the flow of working medium within the second fluid circuit (2). The circuit pump (36b) can also be used to maintain circulation of the secondary fluid circuit (2).

Fresh or distilled water is drawn from each plant (40a, 40b) in individual fresh water lines (19a, 19b) which are combined into distilled water line (19) to be communicated to the electrolyser (49).

In the system (102) it is anticipated that the electrolyser (49) will only use a portion of the freshwater (20) produced from the desalination plants (40a, 40b) and as such, there will be additional fresh water generated for sale which is collected in a fresh water collection tank (59).

Additionally, the two desalination plants (40a, 40b) will:
supply two brine outlet lines (21a, 21b), which can be combined into a single brine outlet line (21) to collect the salt brine (39) for sale; and
will feed two salt water return lines (29a, 29b) to return residual salt water to the salt water source (18). Oxygen generated from the electrolyser (49) can also be fed via oxygen supply line (58) back into the salt water return (29, 29a, 29b) which discharges into salt water source (18), to re-oxygenate the warm salt water (16) exiting the MED plants (40a,40b).

As shown in FIG. 3, the hydrogen line (50) and nitrogen line (63) are fed to receiver (25) illustrated as a mixing valve, before being communicated to the injection bore (5a) of the well (5).

The primary fluid circuit (1) of FIG. 3 can also comprise one or more separators (37a, 37b) to remove unreacted hydrogen and nitrogen gases from the fluid ammonia (4) in the primary fluid circuit (1). In FIG. 3 a first separator (37a) is incorporated into the primary fluid circuit (1) between the well outlet (11b) and the heat exchanger (30) to remove unreacted gases from the primary fluid circuit (1) and direct them into the redirection line (61).

In FIG. 3 a second separator (37b) is incorporated into the ammonia outlet line (64) to remove unreacted gases from the fluid ammonia (4) before collection and to direct them into the redirection line (61).

Although not illustrated in FIG. 3, it is contemplated that a hydrogen compressor (57) and a nitrogen compressor (14) can be incorporated into the system (102) to compress the hydrogen and nitrogen being delivered to the receiver (25). The hydrogen compressor (57) incorporated into the hydrogen supply line (50), and the nitrogen compressor (14) incorporated into the nitrogen supply line (63).

System (102) is shown to draw salt water (16) from the ocean as the salt water source (18); however, it is contemplated that the salt water required can also be drawn from a salt water bore, or a plurality of salt water bores located inland, as described in relation to other embodiments of the disclosure.

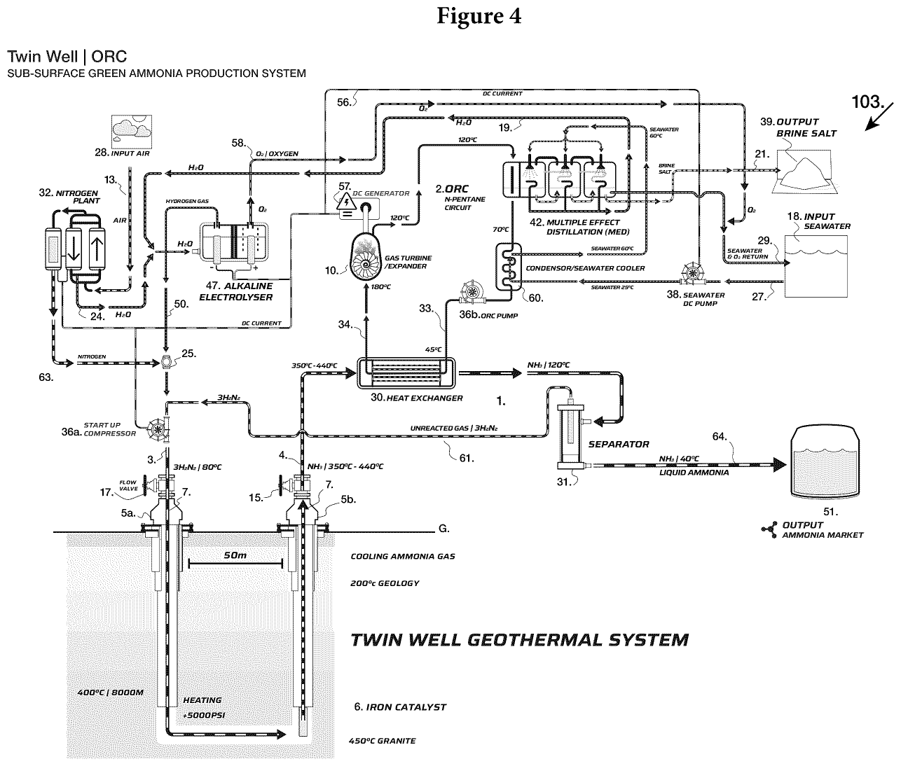

Turning now to FIG. 4, there is illustrated a sub-surface geothermal ammonia production system (103) comprising a single injection bore (5a) and a single production bore (5b) spaced apart from each other. The system (103) uses a secondary fluid circuit (2) as described herein in relation to FIG. 3; however, only a single desalination plant (40) is illustrated, powered by the secondary fluid circuit (2).

The system (103) draws heated fluid ammonia (4) from the production bore (5b) via well outlet (11b) and directs the fluid ammonia (4) to the heat exchanger (30). The fluid ammonia is reduced in temperature from about 350° C.-400° C. to about 120° C. on exit from the heat exchanger (30). Although not shown in FIG. 4 a second MED desalination plant or salt water cooler/heat exchanger can be installed, to draw thermal energy from the primary fluid circuit (1), located between the heat exchanger (30) and the gas separator (37) to further reduce the temperature of the fluid ammonia (4) prior to collection. The anticipated layout would be similar to that of system (102) as illustrated in FIG. 3.

After exiting the heat exchanger (30), the fluid ammonia (4) is passed through the separator (37) to draw off any unreacted gases which are fed to the unreacted gas return line (61). The fluid ammonia (4) is drawn from the separator (37) at about 40° C. into the ammonia line (64) and fed to the storage tank (51) for storage or sale. While the separator (37) of the primary fluid circuit (1) in system (103) does not illustrate a cooler, it is contemplated that a cooler (31) or cooler/separator (37) can be incorporated into the circuit (1) to further cool the fluid ammonia (4) if required before the storage tank (51).

The unreacted gas return line (61) is fed back to the well inlet (11a) of the injection bore (5a) to be reintroduced to the well (5). The unreacted gases can be fed through the inlet compressor (36a) after being mixed with the fluid mixture of hydrogen and nitrogen (3) from the receiver (25) to be forced into the injection bore (5a) under pressure.

The secondary fluid circuit (2) of system (103) functions as described herein in relation to system (102), wherein the thermal energy in the secondary fluid circuit (2) is used to drive the turbine (10) to power the electrical generator (57) and also to power the desalination plant (40).

Turning now to FIG. 5 there is illustrated a sub-surface geothermal ammonia production system (104) comprising a single injection bore (5a) and four production bores (5b) feeding heated fluid ammonia (4) to the primary fluid circuit (1). Similar to the well (5) arrangement of system (101), the injection bore (5a) provides an inlet flow valve (17) for regulating the supply of the fluid mixture of nitrogen and hydrogen (3) into the well (5), while each of the production bores (5b) provide an inlet flow valve (15) for regulating the supply of fluid ammonia (4) exiting the well outlet (11b). The remaining components of system (104) are as described herein in relation to system (103).

FIG. 6 illustrates a simplified schematic view of a separator (37) to separate the fluid ammonia (4) into unreacted nitrogen and hydrogen gases, and ammonia in liquid form. The separator comprises a body (68) having a single inlet from the primary fluid circuit (1) receiving heated fluid ammonia (4) and a pair of outlets: a first liquid outlet supplying the ammonia supply line (64) and a second gas outlet supplying the unreacted gas redirection line (61). The first liquid outlet is located towards a bottom of the body (68) where liquids will naturally accumulate under gravity. The second gas outlet is located towards a top of the body (68) to capture and channel gases that will rise above the fluid and naturally separated within the separator (37).

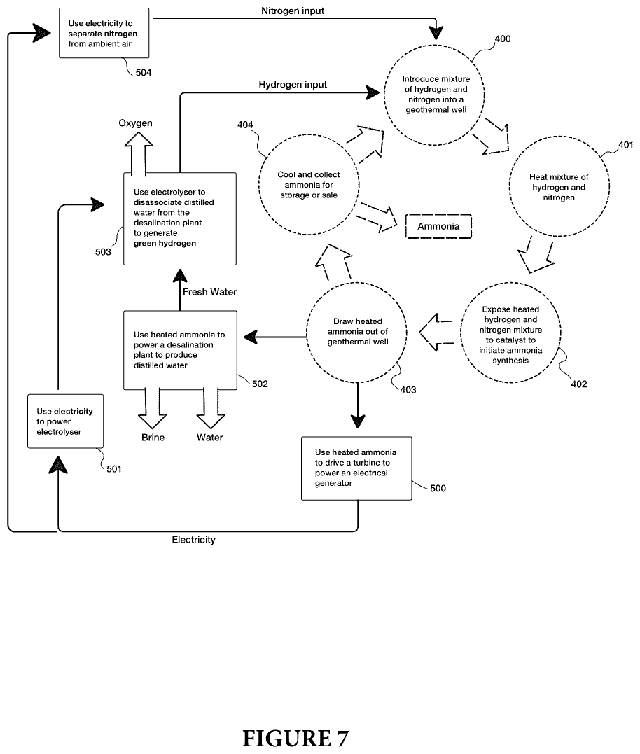

Referring to FIG. 7, there is a flow chart illustrating the primary steps of the sub-surface geothermal ammonia production method (400-404), and the secondary processes (500-504) powered or supplied by the primary steps for sustained ammonia production.

The method of sub-surface geothermal ammonia production, comprising the steps: introducing a fluid mixture of hydrogen and nitrogen into an injection bore of a geothermal well, such that as the fluid mixture of hydrogen and nitrogen is drawn down the well it absorbs thermal energy from geology surrounding the well; exposing the heated fluid mixture of hydrogen and nitrogen to a catalyst within the well to initiate ammonia synthesis and create heated fluid ammonia; drawing the heated fluid ammonia from a production bore of the geothermal well; and cooling and collecting the heated fluid ammonia for storage. The method is schematically illustrated in FIG. 7.

The method of sub-surface geothermal ammonia production requires no electricity and uses the thermal syphoning effect for energy requirements to maintain a primary fluid circuit (1) drawing the fluid mixture of nitrogen and hydrogen into the injection bore (5a) of the well (5) and drawing the heated fluid ammonia (4) from the production bore (5b) of the well (5). The thermal syphoning effect is also used to deliver the heated fluid ammonia (4) to a desalination plant (40) to convert salt water (16) from the salt water source (18) to distilled water (20) which is communicated via distilled water line (19) to feed a hydrogen electrolyser (49) supplying “green” hydrogen to the well (5). In this manner, the fluid ammonia (4) produced from the system (100,101,102,103,104) can be referred to as “green ammonia”.

The method comprises the following primary steps:
Step (400) introducing a fluid mixture of hydrogen and nitrogen into an injection bore of a geothermal well.
Step (401) heating the fluid mixture of hydrogen and nitrogen as it is drawn down the well and absorbs thermal energy from geology surrounding the well.
Step (402) exposing the heated fluid mixture of hydrogen and nitrogen to a catalyst within the well to initiate ammonia synthesis and create heated fluid ammonia.
Step (403) drawing the heated fluid ammonia from a production bore of the geothermal well.
Step (404) cooling and collecting the heated fluid ammonia for storage.

The primary steps (400)-(403) feed and power the secondary processes, wherein:
Step (500) takes the thermal energy from the fluid ammonia (4) and communicates this energy to drive a turbine (10).
Step (501) takes the mechanical work (12) created by the turbine and delivers this energy to generator (47) to generate electricity.
Step (502) takes thermal energy from the fluid ammonia (4) and communicates this energy to the desalination plant (40) to distil salt water into distilled water.
Step (503) takes the distilled water from step (502) and the electricity from step (501) to supply distilled water and electrical power to a hydrogen electrolyser to disassociate the distilled water and produce hydrogen to supply step (400) and feed the well.

Step (504) takes the electricity from the electrical generator in step (501) and powers the nitrogen plant to draw nitrogen from ambient air to supply step (400) and feed the well.

The heated fluid ammonia (4) is circulated in a primary fluid circuit (1) to drive a turbine (10) to produce a mechanical output (12) to power an electrical generator (47). The thermal energy of the heated fluid ammonia (4) is also used to power a desalination plant (40) for produce distilled water (20) from the salt water source (18). The distilled water (20) communicated via the salt water line (19) and is delivered to the hydrogen electrolyser (49) powered from electricity from the electrical generator (47) to disassociate the distilled water (20) to produce hydrogen. The electricity from the generator (47) is also transmitted via cables (56) to power the nitrogen plant (32) to separate nitrogen from ambient air (58), whereby the harvested nitrogen and generated hydrogen are mixed before being introduced into the geothermal well (5) to feed the ammonia synthesis within the well (5).

The thermal energy of the primary fluid circuit (1) can be transferred to the secondary fluid circuit (2) wherein the working medium (33) of the secondary circuit (2) transfers the thermal energy to the turbine (10) to generate electricity and/or to the desalination plant (40) or a secondary desalination plant (40a) as described herein in relation to FIGS. 3-5.

In some embodiments the method further comprises a step of compressing the fluid mixture of hydrogen and nitrogen (3) via an inlet compressor (36a) to compress the fluid mixture of hydrogen and nitrogen (3) before being fed to the injection bore (5a) of the well (5). The inlet compressor (36a) is driven from electricity generator by the electrical generator (47).

In some embodiments the method further comprises a step of pumping the heated working medium (34) around the secondary liquid circuit (2) via a circuit pump (36b) to circulate the working medium within the secondary fluid circuit (2). The circuit pump (36b) is driven from electricity generator by the electrical generator (47).

In some embodiments the heated fluid ammonia (4) of the primary fluid circuit (1) is circulated through the desalination plant (40) to distil water therein. In other embodiments, the heated working medium (34) of the secondary fluid circuit (2) is circulated through the desalination plant (40) to distil water therein. In some embodiments, the heated fluid ammonia (4) of the primary fluid circuit (1) is circulated through a first desalination plant (40a) to distil water therein, and the heated working medium (34) of the secondary fluid circuit (2) is circulated through a secondary desalination plant (40b) to distil water therein.

While the nitrogen plant (32) is described herein as separating nitrogen from ambient air, it is also contemplated that the nitrogen could be extracted from water to supply nitrogen to the nitrogen pump (14).

It will be appreciated by persons skilled in the art that numerous variations and modifications may be made to the above-described embodiments, without departing from the scope of the following claims. The present embodiments are, therefore, to be considered in all respects as illustrative of the scope of protection, and not restrictively.

Although good faith indications of the commercial efficiency of the present disclosure are provided below, these are provided for illustrative purposes, and the figures provided (e.g. the relative costs of energy) should not be taken as limiting, or as binding or limiting the present disclosure. The precise commercial utility of any particular embodiment will depend on numerous factors specific to that embodiment of the disclosure, and the commercial circumstances at the time.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

As used herein and in the appended claims, the singular form of a word includes the plural, unless the context clearly dictates otherwise. Thus, the references “a,” “an” and “the” are generally inclusive of the plurals of the respective terms. For example, reference to “a feature” includes a plurality of such “features.” The term “and/or” used in the context of “X and/or Y” should be interpreted as “X,” or “Y,” or “X and Y.

It is to be understood that, if any prior art publication is referred to herein, such reference does not constitute an admission that the publication forms a part of the common general knowledge in the art, in Australia or any other country.

In the claims which follow and in the preceding description of the disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

LEGEND

| No. | Description | No. | Description |
|---|---|---|---|
| 100 | Sub-surface geothermal | 103 | Sub-surface geothermal |
| | ammonia production | | ammonia production |
| | system - single well | | system - twin well ORC |
| 101 | Sub-surface geothermal | 104 | Sub-surface geothermal |
| | ammonia production | | ammonia production |
| | system - multi well | | system - multi well ORC |
| 102 | Sub-surface geothermal | G | Ground |
| | ammonia production | | |
| | system - single well | | |
| | ORC | | |
| 1 | Primary fluid circuit | 32 | Nitrogen Plant |
| 2 | Secondary fluid circuit | 33 | Working medium |
| 3 | Fluid mixture hydrogen + | 34 | Heated working medium |
| | nitrogen | | |
| 4 | Heated fluid Ammonia | 36a | Primary circuit start-up |
| | | | pump |
| 5 | Geothermal well | 36b | ORC Circuit pump |
| 5a | Injection bore | 37 | Separator |
| 5b | Production bore | 38 | Sea water pump |
| 6 | Catalyst | 39 | Brine salt |
| 7 | Well head | 40 | Desalination plant |
| 8 | Support casing | 42 | First chamber |
| 9 | Exterior support collar | 43 | Salt water valve |
| 10 | Turbine/s | 44 | Last chamber |
| 11a | Well inlet/s | 46 | Seals |
| 11b | Well outlet/s | 47 | Electrical Generator |
| 12 | Mechanical output | 49 | Electrolyser |
| 13 | Ambient air line | 50 | Hydrogen line |
| 14 | Nitrogen compressor | 51 | Ammonia collector |
| 15 | Well outlet flow valve | 52 | Cathode |
| 16 | Salt water | 53 | Anode |
| 17 | Well inlet flow valve | 54 | Diaphragm |
| 18 | Salt water source | 55 | Electrolyte solution |
| 19 | Distilled water line | 56 | Power supply |
| 20 | Distilled water | 57 | Hydrogen compressor |
| 21 | Brine outlet | 58 | Oxygen out |
| 22 | Unreacted water | 59 | Fresh water collector |
| 23 | Residual water | 60 | Salt water condenser |
| 24 | Discharged water | 61 | Unreacted gas line |
| 25 | Receiver | 62 | Ammonia meter |
| 26 | Receiver drain | 63 | Nitrogen outtake line |
| 27 | Salt water delivery line | 64 | Ammonia outtake line |
| 28 | Ambient air intake | 65 | Ammonia outlet |
| 29 | Salt water return line | 66 | Outer well casing |
| 30 | Heat Exchanger | 67 | Insulated inner casing |
| 31 | Cooler + Separator | 68 | Separator body |

1-19. (canceled)

20. A sub-surface geothermal ammonia production system, comprising:
a geothermal well having an inlet in fluid communication with an injection bore, and an outlet in fluid communication with a production bore, the inlet configured to receive a fluid mixture of hydrogen and nitrogen, and the outlet producing a fluid ammonia; and
a catalyst disposed within the geothermal well;
wherein the fluid mixture of hydrogen and nitrogen is drawn into the injection bore of the geothermal well absorbing thermal energy from geology surrounding the well before being directed into the production bore of the geothermal well, whereby the heated fluid mixture of hydrogen and nitrogen contacts the catalyst to convert the fluid mixture of hydrogen and nitrogen into the fluid ammonia within the well.

21. The system of claim 20, wherein the fluid mixture of hydrogen and nitrogen is drawn into the injection bore of the geothermal well by a thermal syphoning effect, and the fluid ammonia is forced out of the production bore of the geothermal well by the thermal syphoning effect.

22. The system of claim 20, wherein the fluid ammonia is drawn from the outlet of the production bore into a primary fluid circuit to drive a first turbine powering an electrical generator.

23. The system of claim 22, wherein the primary fluid circuit delivers thermal energy from the fluid ammonia to a desalination plant configured to produce distilled water from a salt water source.

24. The system of claim 23, wherein the distilled water from the desalination plant is communicated to a hydrogen electrolyser to produce hydrogen.

25. The system of claim 24, wherein the hydrogen electrolyser is powered by electricity from the electrical generator.

26. The system of claim 25, wherein the hydrogen from the electrolyser is communicated to a receiver to be mixed with a nitrogen source to create the fluid mixture of hydrogen and nitrogen for delivery to the injection bore of the geothermal well.

27. The system of 26, further comprising a nitrogen plant to harvest nitrogen from ambient air to provide the nitrogen source.

28. The system of claim 27, wherein the nitrogen plant is powered by electricity from the electrical generator.

29. A sub-surface geothermal ammonia production system, comprising:
a geothermal well having an injection bore and a production bore, the injection bore drawing a fluid mixture of hydrogen and nitrogen into the well and forcing the fluid mixture into contact with a catalyst such that the production bore delivers a heated, pressurised fluid ammonia to a primary fluid circuit;
a desalination plant configured to received thermal energy from the primary fluid circuit to convert a salt water source into distilled water;
a turbine driven from the primary fluid circuit configured to power an electrical generator to generate electricity; and
an electrolyser filled with distilled water from the desalination plant and powered by electricity generated from the electrical generator to thereby disassociate the distilled water to produce a hydrogen output, the hydrogen output directed to a receiving tank for mixing with a nitrogen source to form the fluid mixture of hydrogen and nitrogen for introduction into the injection bore of the geothermal well,
wherein the fluid ammonia of the primary fluid circuit, having dissipated thermal energy to the turbine and the desalination plant, is collected in fluid form.

30. The system of claim 20, wherein the fluid ammonia is drawn through a cooler before being collected.

31. The system of claim 20, wherein the catalyst contains iron.

32. The system of claim 20, wherein the catalyst is removably disposed within the production bore of the well.

33. The system of claim 20, to wherein the catalyst extends along the production bore for at least 500 metres.

34. The system of claim 20, wherein the catalyst is disposed deeply within the geothermal well.

35. A method of sub-surface geothermal ammonia production, comprising:
introducing a fluid mixture of hydrogen and nitrogen into an injection bore of a geothermal well, such that as the fluid mixture of hydrogen and nitrogen is drawn down the well it absorbs thermal energy from geology surrounding the well;
exposing the heated fluid mixture of hydrogen and nitrogen to a catalyst within the well to initiate ammonia synthesis and create heated fluid ammonia;
drawing the heated fluid ammonia from a production bore of the geothermal well; and
cooling and collecting the heated fluid ammonia.

36. The method of claim 35, further comprising charging a primary fluid circuit with thermal energy from the heated fluid ammonia to thereby power a turbine to generate electricity and to distil salt water into distilled water within a desalination plant.

37. The method of claim 36, further comprising communicating the distilled water to an electrolyser and powering the electrolyser with electricity generated by the turbine, to disassociate the distilled water and produce green hydrogen.

38. The method of claim 37, further comprising combining the green hydrogen with a nitrogen source to feed the injection bore of the geothermal well to sustain ammonia synthesis within the well.

39. The method of claim 38, further comprising harvesting nitrogen from the ambient air using a nitrogen plant to provide the nitrogen source, and powering the nitrogen plant with electricity generated by the turbine.
